(19) United States
(12) Patent Application Publication
(10) Pub. No.: US 2025/0203671 A1
(43) Pub. Date: Jun. 19, 2025

(54) TWO-STEP RANDOM ACCESS ENHANCEMENTS FOR BEAM BASED OPERATION FOR NETWORK ENERGY SAVINGS

(71) Applicant: QUALCOMM Incorporated, San Diego, CA (US)

(72) Inventors: Ahmed Attia ABOTABL, San Diego, CA (US); Hung Dinh LY, San Diego, CA (US)

(21) Appl. No.: 18/544,199

(22) Filed: Dec. 18, 2023

(51) Int. Cl. H04W 74/0836; H04W 72/044; H04W 72/1268; H04W 74/08

(52) U.S. Cl. CPC H04W 74/0836; H04W 72/046; H04W 72/1268; H04W 74/0891

(57) ABSTRACT

Methods, systems, and devices for wireless communications are described. The described techniques may enable a network entity to configure a user equipment (UE) with non-uniform physical uplink shared channel (PUSCH) occasions across multiple beams for a random access channel message. For example, the network entity may transmit a separate configuration for each beam such that each beam may be configured with different quantities of PUSCH occasions. Additionally, or alternatively, the network entity may transmit a single configuration that includes multiple parameters corresponding to each beam. Accordingly, the network entity may configure the UE with varying quantities of PUSCH occasions for each beam. Additionally, or alternatively, the network entity may configure the UE with a uniform quantity of PUSCH occasions for each beam, and the UE and the network entity may determine to select or discard a subset of PUSCH occasions configured for some of the beams.

### FIELD OF TECHNOLOGY

The following relates to wireless communications, including two-step random access enhancements for beam based operation for network energy savings.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support two-step random access enhancements for beam based operation for network energy savings. For example, the described techniques may enable a network entity to configure a user equipment (UE) with non-uniform physical uplink shared channel (PUSCH) occasions across multiple beams for a random access channel (RACH) message. For example, the network entity may transmit a separate configuration for each beam such that each beam may be configured with different quantities of PUSCH occasions. Additionally, or alternatively, the network entity may transmit a single configuration that includes multiple parameters corresponding to each beam. Accordingly, the network entity may configure the UE with varying quantities of PUSCH occasions for each beam. Additionally, or alternatively, the network entity may configure the UE with a uniform quantity of PUSCH occasions for each beam, and the UE and the network entity may determine to select or discard a subset of some PUSCH occasions configured for some of the beams.

A method for wireless communications by a UE is described. The method may include receiving control information indicating one or more PUSCH occasion configurations for a first message of a two-step RACH procedure, where the one or more PUSCH occasion configurations are associated with a set of multiple synchronization signal block (SSB) indices and transmitting, based on the control information, the first message of the two-step RACH procedure via a first beam associated with a first SSB index of the set of multiple SSB indices and according to a first PUSCH occasion configuration, where the first PUSCH occasion configuration is different from a second PUSCH occasion configuration for a second beam associated with a second SSB index of the set of multiple SSB indices based on a first attribute of the first beam being different than a second attribute of the second beam.

A UE for wireless communications is described. The UE may include one or more memories storing processor executable code, and one or more processors coupled with the one or more memories. The one or more processors may individually or collectively operable to execute the code to cause the UE to receive control information indicating one or more PUSCH occasion configurations for a first message of a two-step RACH procedure, where the one or more PUSCH occasion configurations are associated with a set of multiple SSB indices and transmit, based on the control information, the first message of the two-step RACH procedure via a first beam associated with a first SSB index of the set of multiple SSB indices and according to a first PUSCH occasion configuration, where the first PUSCH occasion configuration is different from a second PUSCH occasion configuration for a second beam associated with a second SSB index of the set of multiple SSB indices based on a first attribute of the first beam being different than a second attribute of the second beam.

Another UE for wireless communications is described. The UE may include means for receiving control information indicating one or more PUSCH occasion configurations for a first message of a two-step RACH procedure, where the one or more PUSCH occasion configurations are associated with a set of multiple SSB indices and means for transmitting, based on the control information, the first message of the two-step RACH procedure via a first beam associated with a first SSB index of the set of multiple SSB indices and according to a first PUSCH occasion configuration, where the first PUSCH occasion configuration is different from a second PUSCH occasion configuration for a second beam associated with a second SSB index of the set of multiple SSB indices based on a first attribute of the first beam being different than a second attribute of the second beam.

A non-transitory computer-readable medium storing code for wireless communications is described. The code may include instructions executable by one or more processors to receive control information indicating one or more PUSCH occasion configurations for a first message of a two-step RACH procedure, where the one or more PUSCH occasion configurations are associated with a set of multiple SSB indices and transmit, based on the control information, the first message of the two-step RACH procedure via a first beam associated with a first SSB index of the set of multiple SSB indices and according to a first PUSCH occasion configuration, where the first PUSCH occasion configuration is different from a second PUSCH occasion configuration for a second beam associated with a second SSB index of the set of multiple SSB indices based on a first attribute of the first beam being different than a second attribute of the second beam.

In some examples of the method, user equipment (UEs), and non-transitory computer-readable medium described herein, receiving the control information may include operations, features, means, or instructions for receiving a first information element indicating the first PUSCH occasion configuration, where the first PUSCH occasion configuration may be associated with a first quantity of PUSCH occasions and receiving a second information element indicating the second PUSCH occasion configuration, where the second PUSCH occasion configuration may be associated with a second quantity of PUSCH occasions different from the first quantity.

In some examples of the method, user equipment (UEs), and non-transitory computer-readable medium described herein, the first information element includes an indication of the first SSB index and and the second information element includes an indication of the second SSB index.

In some examples of the method, user equipment (UEs), and non-transitory computer-readable medium described herein, the first information element includes an indication of a third SSB index associated with a third beam and a third PUSCH occasion configuration for the third beam may be associated with the first quantity of PUSCH occasions.

Some examples of the method, user equipment (UEs), and non-transitory computer-readable medium described herein may further include operations, features, means, or instructions for identifying a mapping between the first SSB index and the first PUSCH occasion configuration based on the first attribute.

In some examples of the method, user equipment (UEs), and non-transitory computer-readable medium described herein, receiving the control information may include operations, features, means, or instructions for receiving a first information element including a first parameter indicating the first PUSCH occasion configuration and a second parameter indicating the second PUSCH occasion configuration, where the first PUSCH occasion configuration may be associated with a first quantity of PUSCH occasions and the second PUSCH occasion configuration may be associated with a second quantity of PUSCH occasions different from the first quantity.

In some examples of the method, user equipment (UEs), and non-transitory computer-readable medium described herein, the first information element includes an indication of a mapping between the first SSB index and the first parameter and a mapping between the second SSB index and the second parameter.

In some examples of the method, user equipment (UEs), and non-transitory computer-readable medium described herein, the first information element includes an indication of a mapping between the first parameter and a third SSB index associated with a third beam and a third PUSCH occasion configuration for the third beam may be associated with the first quantity of PUSCH occasions.

Some examples of the method, user equipment (UEs), and non-transitory computer-readable medium described herein may further include operations, features, means, or instructions for identifying a mapping between the first SSB index and the first PUSCH occasion configuration based on the first attribute.

In some examples of the method, user equipment (UEs), and non-transitory computer-readable medium described herein, receiving the control information may include operations, features, means, or instructions for receiving an information element indicating a quantity of PUSCH occasions associated with the set of multiple SSB indices.

Some examples of the method, user equipment (UEs), and non-transitory computer-readable medium described herein may further include operations, features, means, or instructions for selecting a first subset of the quantity of PUSCH occasions based on the first attribute and a second subset of the quantity of PUSCH occasions based on the second attribute, where the first subset includes the first PUSCH occasion configuration and the second subset includes the second PUSCH occasion configuration.

Some examples of the method, user equipment (UEs), and non-transitory computer-readable medium described herein may further include operations, features, means, or instructions for receiving a control message indicating one or more thresholds, where selecting the first subset and the second subset may be based on the one or more thresholds.

Some examples of the method, user equipment (UEs), and non-transitory computer-readable medium described herein may further include operations, features, means, or instructions for receiving a control message indicating a first quantity of PUSCH occasions in the first subset and a second quantity of PUSCH occasions in the second subset, where the first quantity and the second quantity may be associated with the first SSB index and the second SSB index, respectively, and where selecting the first subset and the second subset may be based on the first quantity and the second quantity.

In some examples of the method, user equipment (UEs), and non-transitory computer-readable medium described herein, the first attribute and the second attribute include a first quantity of RACH occasions associated with the first SSB index and a second quantity of RACH occasions associated with the second SSB index, respectively.

A method for wireless communications by a network entity is described. The method may include outputting control information indicating one or more PUSCH occasion configurations for a first message of a two-step RACH procedure, where the one or more PUSCH occasion configurations are associated with a set of multiple SSB indices and obtaining, based on the control information, the first message of the two-step RACH procedure via a first beam associated with a first SSB index of the set of multiple SSB indices and according to a first PUSCH occasion configuration, where the first PUSCH occasion configuration is different from a second PUSCH occasion configuration for a second beam associated with a second SSB index of the set of multiple SSB indices based on a first attribute of the first beam being different than a second attribute of the second beam.

A network entity for wireless communications is described. The network entity may include one or more memories storing processor executable code, and one or more processors coupled with the one or more memories. The one or more processors may individually or collectively operable to execute the code to cause the network entity to output control information indicating one or more PUSCH occasion configurations for a first message of a two-step RACH procedure, where the one or more PUSCH occasion configurations are associated with a set of multiple SSB indices and obtain, based on the control information, the first message of the two-step RACH procedure via a first beam associated with a first SSB index of the set of multiple SSB indices and according to a first PUSCH occasion configuration, where the first PUSCH occasion configuration is different from a second PUSCH occasion configuration for a second beam associated with a second SSB index of the set of multiple SSB indices based on a first attribute of the first beam being different than a second attribute of the second beam.

Another network entity for wireless communications is described. The network entity may include means for outputting control information indicating one or more PUSCH occasion configurations for a first message of a two-step RACH procedure, where the one or more PUSCH occasion configurations are associated with a set of multiple SSB indices and means for obtaining, based on the control information, the first message of the two-step RACH procedure via a first beam associated with a first SSB index of the set of multiple SSB indices and according to a first PUSCH occasion configuration, where the first PUSCH occasion configuration is different from a second PUSCH occasion configuration for a second beam associated with a second SSB index of the set of multiple SSB indices based on a first attribute of the first beam being different than a second attribute of the second beam.

A non-transitory computer-readable medium storing code for wireless communications is described. The code may include instructions executable by one or more processors to output control information indicating one or more PUSCH occasion configurations for a first message of a two-step RACH procedure, where the one or more PUSCH occasion configurations are associated with a set of multiple SSB indices and obtain, based on the control information, the first message of the two-step RACH procedure via a first beam associated with a first SSB index of the set of multiple SSB indices and according to a first PUSCH occasion configuration, where the first PUSCH occasion configuration is different from a second PUSCH occasion configuration for a second beam associated with a second SSB index of the set of multiple SSB indices based on a first attribute of the first beam being different than a second attribute of the second beam.

In some examples of the method, network entities, and non-transitory computer-readable medium described herein, outputting the control information may include operations, features, means, or instructions for outputting a first information element indicating the first PUSCH occasion configuration, where the first PUSCH occasion configuration may be associated with a first quantity of PUSCH occasions and outputting a second information element indicating the second PUSCH occasion configuration, where the second PUSCH occasion configuration may be associated with a second quantity of PUSCH occasions different from the first quantity.

In some examples of the method, network entities, and non-transitory computer-readable medium described herein, the first information element includes an indication of the first SSB index and and the second information element includes an indication of the second SSB index.

In some examples of the method, network entities, and non-transitory computer-readable medium described herein, the first information element includes an indication of a third SSB index associated with a third beam and a third PUSCH occasion configuration for the third beam may be associated with the first quantity of PUSCH occasions.

Some examples of the method, network entities, and non-transitory computer-readable medium described herein may further include operations, features, means, or instructions for identifying a mapping between the first SSB index and the first PUSCH occasion configuration based on the first attribute.

In some examples of the method, network entities, and non-transitory computer-readable medium described herein, outputting the control information may include operations, features, means, or instructions for outputting a first information element including a first parameter indicating the first PUSCH occasion configuration and a second parameter indicating the second PUSCH occasion configuration, where the first PUSCH occasion configuration may be associated with a first quantity of PUSCH occasions and the second PUSCH occasion configuration may be associated with a second quantity of PUSCH occasions different from the first quantity.

In some examples of the method, network entities, and non-transitory computer-readable medium described herein, the first information element includes an indication of a mapping between the first SSB index and the first parameter and a mapping between the second SSB index and the second parameter.

In some examples of the method, network entities, and non-transitory computer-readable medium described herein, the first information element includes an indication of a mapping between the first parameter and a third SSB index associated with a third beam and a third PUSCH occasion configuration for the third beam may be associated with the first quantity of PUSCH occasions.

Some examples of the method, network entities, and non-transitory computer-readable medium described herein may further include operations, features, means, or instructions for identifying a mapping between the first SSB index and the first PUSCH occasion configuration based on the first attribute.

In some examples of the method, network entities, and non-transitory computer-readable medium described herein, outputting the control information may include operations, features, means, or instructions for outputting an information element indicating a quantity of PUSCH occasions associated with the set of multiple SSB indices.

Some examples of the method, network entities, and non-transitory computer-readable medium described herein may further include operations, features, means, or instructions for selecting a first subset of the quantity of PUSCH occasions based on the first attribute and a second subset of the quantity of PUSCH occasions based on the second attribute, where the first subset includes the first PUSCH occasion configuration and the second subset includes the second PUSCH occasion configuration.

Some examples of the method, network entities, and non-transitory computer-readable medium described herein may further include operations, features, means, or instructions for outputting a control message indicating one or more thresholds, where selecting the first subset and the second subset may be based on the one or more thresholds.

Some examples of the method, network entities, and non-transitory computer-readable medium described herein may further include operations, features, means, or instructions for outputting a control message indicating a first quantity of PUSCH occasions in the first subset and a second quantity of PUSCH occasions in the second subset, where the first quantity and the second quantity may be associated with the first SSB index and the second SSB index, respectively, and where selecting the first subset and the second subset may be based on the first quantity and the second quantity.

In some examples of the method, network entities, and non-transitory computer-readable medium described herein, the first attribute and the second attribute include a first quantity of RACH occasions associated with the first SSB index and a second quantity of RACH occasions associated with the second SSB index, respectively.

### BRIEF DESCRIPTION OF THE DRAWINGS

FIG. 1 shows an example of a wireless communications system that supports two-step random access enhancements for beam based operation for network energy savings in accordance with one or more aspects of the present disclosure.

FIG. 2 shows an example of a wireless communications system that supports two-step random access enhancements for beam based operation for network energy savings in accordance with one or more aspects of the present disclosure.

FIG. 3 shows an example of a process flow that supports two-step random access enhancements for beam based operation for network energy savings in accordance with one or more aspects of the present disclosure.

FIGS. 4 and 5 show block diagrams of devices that support two-step random access enhancements for beam based operation for network energy savings in accordance with one or more aspects of the present disclosure.

FIG. 6 shows a block diagram of a communications manager that supports two-step random access enhancements for beam based operation for network energy savings in accordance with one or more aspects of the present disclosure.

FIG. 7 shows a diagram of a system including a device that supports two-step random access enhancements for beam based operation for network energy savings in accordance with one or more aspects of the present disclosure.

FIGS. 8 and 9 show block diagrams of devices that support two-step random access enhancements for beam based operation for network energy savings in accordance with one or more aspects of the present disclosure.

FIG. 10 shows a block diagram of a communications manager that supports two-step random access enhancements for beam based operation for network energy savings in accordance with one or more aspects of the present disclosure.

FIG. 11 shows a diagram of a system including a device that supports two-step random access enhancements for beam based operation for network energy savings in accordance with one or more aspects of the present disclosure.

FIGS. 12 through 17 show flowcharts illustrating methods that support two-step random access enhancements for beam based operation for network energy savings in accordance with one or more aspects of the present disclosure.

### DETAILED DESCRIPTION

In some wireless communication systems, a user equipment (UE) may use a two-step random access channel (RACH) procedure to establish a connection with a network entity. That is, the UE may transmit a first message (e.g., msgA) of the RACH procedure to the network entity, and may monitor for a random access response message (e.g., msgB) from the network entity. The network entity may accordingly configure the UE with resources (e.g., physical uplink shared channel (PUSCH) occasions) for multiple beams (e.g., beams in multiple directions) to transmit the first message of the RACH procedure.

A direction via which the network entity provides coverage may be associated with a synchronization signal block (SSB) index. For example, the network entity may transmit a respective SSB in each respective direction for which the network entity provides coverage, with each SSB being associated with (e.g., identifiable by) a corresponding SSB index. Thus, an SSB index may be associated with a direction (e.g., a beam) in which a corresponding SSB is transmitted by the network entity. Accordingly, different SSB indices (or, “indices”) may be associated with different directions or coverage regions served by the network entity. In some systems, different directions or coverage regions may serve differing quantities of UEs. For example, a first coverage region served by a network entity may include a relatively large quantity of UEs (e.g., the first coverage region may include an office building) and a second coverage region served by the network entity may include a relatively small quantity of UEs (e.g., the second coverage region may include a lake next to the office building). In systems in which the network entity allocates or configures a same quantity of PUSCH occasions and a same quantity of random access preambles for each SSB index, PUSCH occasions associated with the first coverage region may be highly congested while one or more PUSCH occasions associated with the second coverage region may be unused (e.g., wasted). In other words, allocating or configuring a same quantity of PUSCH occasions for each SSB index may result in an inefficient resource usage. Moreover, a network entity may be expected monitor all PUSCH occasions allocated or configured for each SSB index, which may result in unnecessary power consumption.

Accordingly, techniques described herein may allow for the network entity to configure non-uniform PUSCH occasions across multiple beams for the first message of the RACH procedure (e.g., msgA). For example, the network entity may transmit a separate configuration for each beam (e.g., for each SSB index) such that each beam may be configured with different quantities of PUSCH occasions. Additionally, or alternatively, the network entity may transmit a single configuration that includes multiple parameters corresponding to each beam. Accordingly, the network entity may configure the UE with varying quantities of PUSCH occasions for each beam via the single configuration. Additionally, or alternatively, the network entity may configure the UE with a uniform quantity of PUSCH occasions for each beam, and the UE and the network entity may determine to select or discard a subset of some PUSCH occasions configured for some of the beams (e.g., according to a predefined rule).

Aspects of the disclosure are initially described in the context of wireless communications systems. Aspects of the disclosure are further illustrated by and described with reference to process flow diagrams, apparatus diagrams, system diagrams, and flowcharts that relate to two-step random access enhancements for beam based operation for network energy savings.

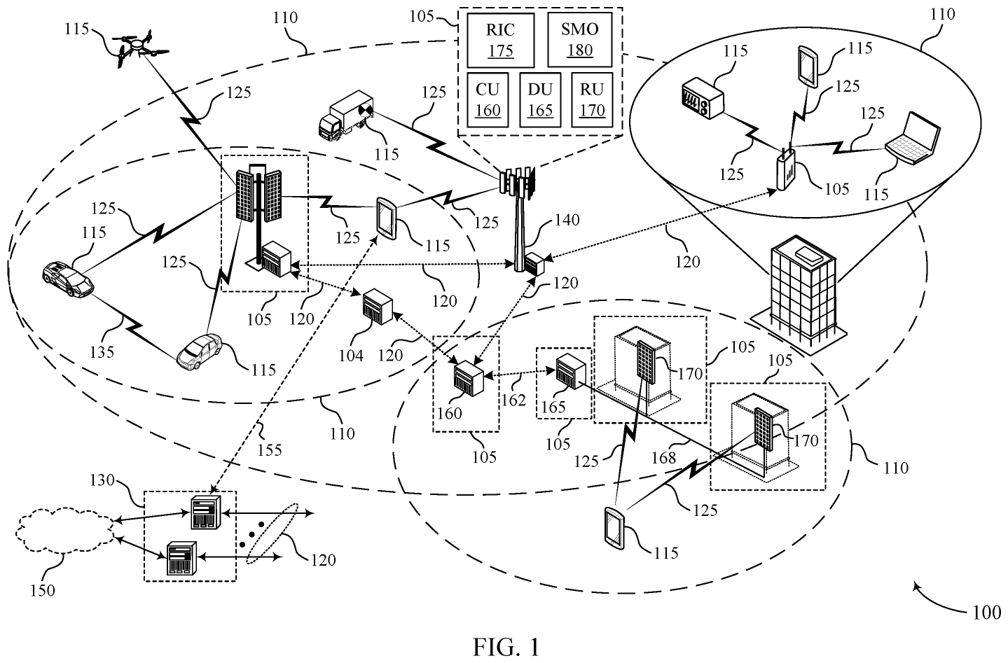

FIG. 1 shows an example of a wireless communications system 100 that supports two-step random access enhancements for beam based operation for network energy savings in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support two-step random access enhancements for beam based operation for network energy savings as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

One or more wireless communication devices (e.g., one or more network entities 105 or one or more UEs 115, or any combination thereof) may support one or more mechanisms, rules, operational procedures, or operating modes associated with NES. For example, one or more wireless communication devices may achieve NES via dynamic adaptation of spatial and power domain, cell discontinuous transmission (DTX), cell discontinuous reception (DRX), or any combination thereof. In some aspects, NES may be associated with relatively less power or energy (e.g., electrical energy) consumption (e.g., battery power consumption or power grid pull) at the network side to allow the network to have a longer sleep duration. For that purpose, various wireless communications systems and devices may support a relatively more compact SSB transmission, relatively more dynamic PRACH, clustered paging indications, or any combination thereof. In accordance with such techniques, a network entity 105 may transmit or receive signaling in a relatively short duration and, accordingly, save energy by entering and remaining in a sleep state for a relatively longer duration.

In some examples, a network entity 105 may configure a UE 115 with non-uniform PUSCH occasions across multiple beams (e.g., in multiple beam directions) for a first message of a RACH procedure (e.g., msgA). For example, the network entity 105 may transmit a separate configuration for each beam such that each beam may be configured with different quantities of PUSCH occasions. Additionally, or alternatively, the network entity 105 may transmit a single configuration to the UE 115 that includes multiple parameters corresponding to each beam. Accordingly, the network entity 105 may configure the UE 115 with varying quantities of PUSCH occasions for each beam via the single configuration. Additionally, or alternatively, the network entity 105 may configure the UE 115 with a uniform quantity of PUSCH occasions for each beam, and the UE 115 and the network entity 105 may determine to select or discard a subset of some PUSCH occasions configured for some of the beams (e.g., according to a predefined rule).

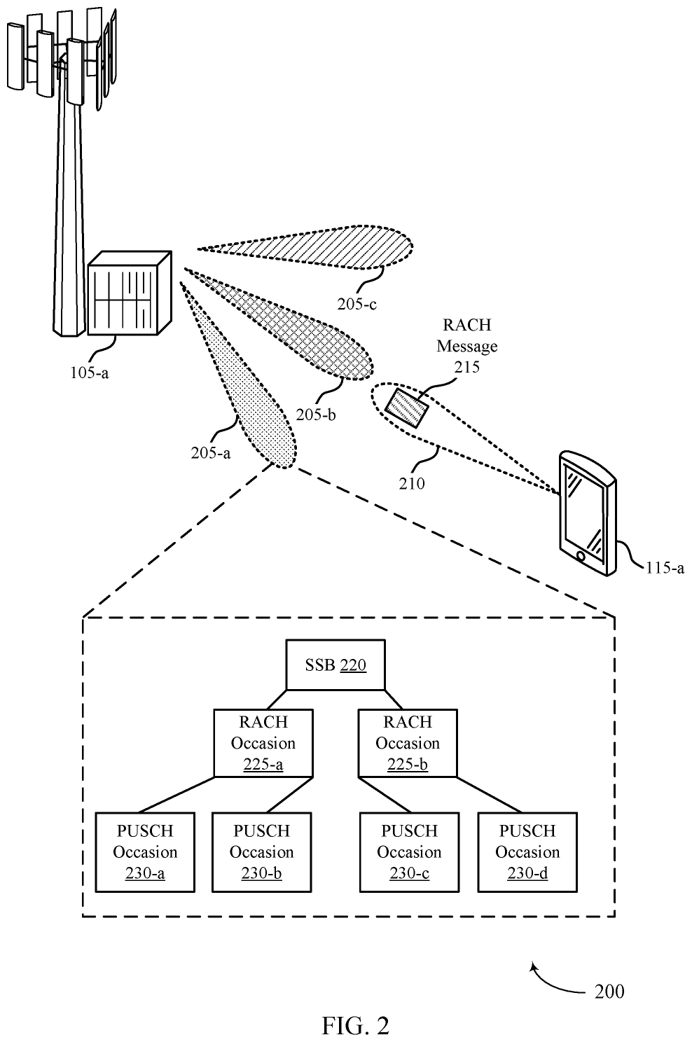

FIG. 2 shows an example of a wireless communications system 200 that supports two-step random access enhancements for beam based operation for network energy savings in accordance with one or more aspects of the present disclosure. The wireless communications system 200 may implement or may be implemented by aspects of the wireless communications system 100. For example, the wireless communications system 200 may include a UE 115 (e.g., a UE 115-a) and a network entity 105 (e.g., a network entity 105-a), which may be examples of the corresponding devices as described with reference to FIG. 1.

A UE 115-a may communicate with a network entity 105-a via one or more beams 205. For example, the network entity 105-a may use a beam 205-a, a beam 205-b, and a beam 205-c to transmit signaling to the UE 115-a. Each of the beam 205-a, the beam 205-b, and the beam 205-c may be used to transmit a respective SSB associated with a respective SSB index. Accordingly, each beam 205 may be mapped to the respective SSB index.

In some examples, the UE 115-a may establish a connection with the network entity 105-a via a RACH procedure. Such a RACH procedure may be a four-step (e.g., Type-1) or two-step (e.g., Type-2) RACH procedure. The UE 115-a may initiate the RACH procedure by transmitting a first RACH message 215 to the network entity 105-a (e.g., via a transmit beam 210). In the example of a four-step RACH procedure, the UE 115-a may transmit the first RACH message 215 (e.g., msg1) via a RACH occasion (e.g., or a physical RACH (PRACH) occasion) 225. For example, the UE 115-a may receive a configuration from the network entity 105-a (e.g., an information element such as ssb-per-RACH-OccasionAndCB-PreamblesPerSSB) indicating a quantity N of SS or physical broadcast channel (PBCH) block indices associated with each RACH occasion 225 and a quantity R of contention-based preambles per each SS/PBCH block index for each RACH occasion 225.

The UE 115-a and the network entity 105-a may map the SSB indices (e.g., and accordingly the beams 205) to the RACH occasions 225 in accordance with an ordering, priority, or hierarchy of preamble index, frequency resource index, time resource index, and RACH slot index. For example, SS/PBCH block indices provided, for example, by ssb-PositionsInBurst in a system information block (SIB) or in a ServingCellConfigCommon information element may be mapped to valid RACH occasions 225 in an order of: first, in increasing order of preamble indices within a single RACH occasion 225; second, in increasing order of frequency resource indices for frequency multiplexed RACH occasions 225; third, in increasing order of time resource indices for time multiplexed RACH occasions 225 within a RACH slot; and fourth, in increasing order of indices for RACH slots. As illustrated with reference to FIG. 2, the SSB 220 associated with the first SSB index may be mapped to a RACH occasion 225-a and a RACH occasion 225-b according to such an ordering.

In the example of a two-step RACH procedure, the UE 115-a may transmit the first RACH message (e.g., msgA) via a PUSCH occasion 230. The UE 115-a may receive a configuration (e.g., via a MsgA-PUSCH-Resource-r16 information element in system information or an RRC message) indicating a quantity of PUSCH occasions 230 for the UE 115-a to transmit the first RACH message 215 (e.g., msgA). In some examples, each beam 205 (e.g., each SSB) may be associated with a same quantity of PUSCH occasions 230. As an illustrative example, an SSB 220 associated with a beam 205-a may be associated with a first RACH occasion 225-a and a second RACH occasion 225-b. The first RACH occasion 225-a may be associated with a PUSCH occasion 230-a and a PUSCH occasions 230-b, and the second RACH occasion 225-b may be associated with a PUSCH occasion 230-c and a PUSCH occasion 230-d. Accordingly, the beam 205-a may be associated with a total of four PUSCH occasions 230. In the example of uniform quantities of PUSCH occasions across beams, therefore, each of the beam 205-b and the beam 205-c may also be associated with four PUSCH occasions. That is, the UE 115-a may receive a parameter (e.g., nrofMsgA-PO-PerSlot) indicating the uniform quantity of PUSCH occasions 230 allocated for each beam 205.

However, such uniform distribution of PUSCH occasions 230 may be inefficient. For example, the network entity 105-a may increase a quantity of PUSCH occasions 230 configured for a beam 205 in a beam direction with relatively higher traffic. Accordingly, the network entity 105-a may also increase the quantity of PUSCH occasions 230 configured for beams 205 in beam directions with relatively lower traffic (e.g., to maintain a uniform quantity of PUSCH occasions 230 configured for each beam 205). The network entity 105-a may therefore increase power consumption related to performing blind decoding for such lower-traffic beams 205. Additionally, the network entity 105-a may not enter a low power or sleep mode while performing such blind decoding. Therefore, enabling the network entity 105-a to allocate non-uniform quantities of PUSCH occasions 230 for each beam 205 may decrease power consumption for the network entity 105-a.

In some aspects, the network entity 105-a may configure the UE 115-a with non-uniform quantities of PUSCH occasions 230 for each beam 205 by transmitting a separate configuration (e.g., a separate MsgA-PUSCH-Resource information element) for each beam 205. The separate configurations may each include a parameter indicating the quantity of PUSCH occasions 230 allocated for the respective beam 205 (e.g., nrofMsgA-PO-PerSlot or nofMsgA-PO-FDM). In some examples, each configuration may include an index (e.g., an SSB index) indicating the beam 205 for which the configuration applies (e.g., a mapping between each configuration and each SSB index). In some examples, if multiple beams 205 are allocated a same quantity of PUSCH occasions 230, the configurations may be grouped. For example, if the network entity 105-a allocates a same quantity of PUSCH occasions for the beam 205-a and the beam 205-b and a different quantity of PUSCH occasions for the beam 205-c, a first configuration may indicate SSB indices associated with the beam 205-a and the beam 205-b and a second configuration may indicate an SSB index associated with the beam 205-b.

In some examples, the UE 115-a (e.g., and the network entity 105-a) may implicitly determine the mapping between each beam 205 (e.g., each SSB index) and each configuration based on a rule associated with an attribute of each beam 205 (e.g., a quantity of RACH occasions 225 associated with each beam 205, a transmit power associated with each respective SSB, an RSRP). For example, the UE 115-a may determine that a beam 205 with SSB index 0 associated with a highest quantity of RACH occasions 225 may be associated with a highest quantity of PUSCH occasions 240, a beam 205 with SSB index 1 associated with a second highest quantity of RACH occasions 225 may be associated with a second highest quantity of PUSCH occasions 230, and so on. In some examples, the UE 115-a (e.g., and the network entity 105-a) may determine the mapping between each configuration and each beam 205 based on one or more other attributes of the beams 205.

In some aspects, the network entity 105-a may configure the UE 115-a with non-uniform quantities of PUSCH occasions 230 for each beam 205 by transmitting a single configuration (e.g., a MsgA-PUSCH-Resource information element). The single configuration may include a list of parameters indicating the respective quantities of PUSCH occasions 230 allocated for each respective beam 205 (e.g., a list of nrofMsgA-PO-PerSlot or nofMsgA-PO-FDM). In some examples, each parameter in the list may include an index (e.g., an SSB index) indicating the beam 205 for which the parameter applies (e.g., a mapping between each parameter and each SSB index). In some examples, if multiple beams 205 are allocated a same quantity of PUSCH occasions 230, the parameters may be grouped. For example, if the network entity 105-a allocates a same quantity of PUSCH occasions for the beam 205-a and the beam 205-b and a different quantity of PUSCH occasions for the beam 205-c, a first parameter of the list of parameters may indicate SSB indices associated with the beam 205-a and the beam 205-b and a second parameter of the list of parameters may indicate an SSB index associated with the beam 205-b.

In some examples, the UE 115-a (e.g., and the network entity 105-a) may implicitly determine the mapping between each beam 205 (e.g., each SSB index) and each parameter of the list of parameters based on a rule associated with an attribute of each beam 205 (e.g., a quantity of RACH occasions 225 associated with each beam 205, a transmit power associated with each respective SSB). For example, the UE 115-a may determine that a beam 205 with SSB index 0 associated with a highest quantity of RACH occasions 225 may be associated with a highest quantity of PUSCH occasions 240, a beam 205 with SSB index 1 associated with a second highest quantity of RACH occasions 225 may be associated with a second highest quantity of PUSCH occasions 230, and so on. In some examples, the UE 115-a (e.g., and the network entity 105-a) may determine the mapping between each parameter and each beam 205 based on one or more other attributes of the beams 205.

In some aspects, the network entity 105-a may transmit a single configuration indicating a uniform quantity of PUSCH occasions 230 for each beam 205. The UE 115-a and the network entity 105-a may each select a subset of the uniform quantity of PUSCH occasions 230 for each beam 205. For example, the UE 115-a and the network entity 105-a may determine a quantity of PUSCH occasions for each beam 205 to ignore or discard (e.g., based on an attribute of each beam 205). For example, in some cases, the UE 115-a may assume that a ratio between the uniform quantity of PUSCH occasions 230 and discarded PUSCH occasions 230 for each beam 205 may be the same as a ratio of a reduction in RACH occasions 225 allocated for each beam. As an illustrative example, if the UE 115-a is configured with two RACH occasions 225 for the beam 205-a and one RACH occasion 225 for the beam 205-b, and the uniform quantity of configured PUSCH occasions 230 is four, the UE 115-a may select four PUSCH occasions for the beam 205-a and select two PUSCH occasions for the beam 205-b (e.g., discard half of the PUSCH occasions for the beam 205-b).

In some examples, the UE 115-a may determine a quantity of PUSCH occasions 230 to select for each beam 205 based on one or more measurements or thresholds. For example, the network entity 105-a may transmit one or more reference signals in each beam direction (e.g., associated with each SSB index) and a list of reference signal received power (RSRP) thresholds. The list of RSRP thresholds may indicate for the UE 115-a to select all of the PUSCH occasions 230 for an SSB index associated with an RSRP below a first threshold, to select a first subset of the PUSCH occasions 230 for an SSB index associated with an RSRP above the first threshold and below a second threshold, and so on. In some examples, the network entity may transmit an explicit indication of respective quantities of PUSCH occasions to be selected in each subset.

The UE 115-a may determine to discard the PUSCH occasions 230 based on an order of the PUSCH occasions 230. For example, the UE 115-a may determine to first discard PUSCH occasions 230 that are FDMed with a highest frequency and latest in time. That is, the selected PUSCH occasions 230 for each beam may be a subset of the uniform quantity of PUSCH occasions 230 that is earliest in time and FDMed with a lowest frequency.

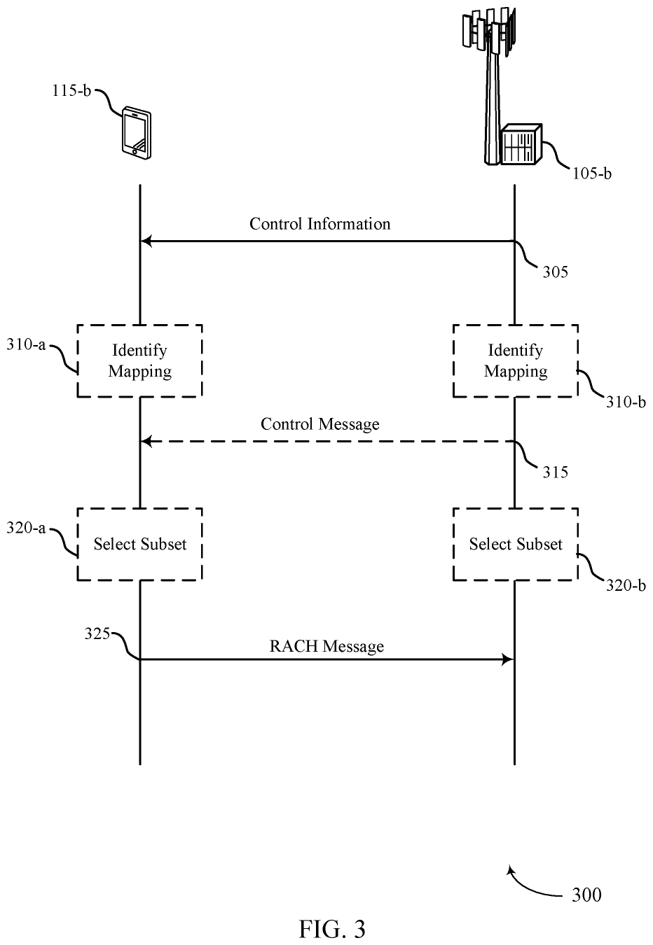

FIG. 3 shows an example of a process flow 300 that supports two-step random access enhancements for beam based operation for network energy savings in accordance with one or more aspects of the present disclosure. The process flow 300 may implement or may be implemented by aspects of the wireless communications system 100 or the wireless communication system 200. For example, the process flow 300 may include a UE 115 (e.g., a UE 115-b) and a network entity 105 (e.g., a network entity 105-b), which may be examples of the corresponding devices as described with reference to FIG. 1.

In the following description of the process flow 300, the operations between the network entity 105-b and the UE 115-b may be transmitted in a different order than the example order shown. Some operations may also be omitted from the process flow 300, and other operations may be added to the process flow 300. Further, although some operations or signaling may be shown to occur at different times for discussion purposes, these operations may actually occur at the same time.

At 305, the UE 115-b may receive, from the network entity 105-b, control information (e.g., one or more RRC messages) indicating one or more PUSCH occasion configurations for a first RACH message of a two-step RACH procedure (e.g., msgA). In some examples, each of the one or more PUSCH configurations may be associated with a plurality of SSB indices (e.g., indices). For example, each PUSCH configuration may be associated with one or more beams, where each of the one or more beams is associated with an SSB index.

In some examples, the one or more PUSCH occasion configurations may be multiple information elements. For example, the UE 115-b may receive a first information element indicating a first PUSCH occasion configuration with a first quantity of PUSCH occasions and a second information element indicating a second PUSCH occasion configuration (e.g., different from the first PUSCH occasion configuration) with a second quantity of PUSCH occasions. In some examples, each information element may indicate a respective SSB index. For example, the first information element may indicate that the first PUSCH occasion configuration is for a first beam associated with a first SSB index, and the second information element may indicate that the second PUSCH occasion configuration is for a second beam associated with a second SSB index. In some examples, each information element may indicate one or more additional SSB indices. For example, the first information element may indicate a third SSB index associated with a third beam (e.g., such that the third beam is associated with a third PUSCH occasion configuration with the first quantity of PUSCH occasions).

In some examples, the one or more PUSCH occasion configurations may be a single information element. For example, the single information element may indicate a uniform quantity of PUSCH occasions associated with each SSB index (e.g., and accordingly with each beam). In some examples, the single information element may indicate a list of parameters (e.g., a first parameter indicating the first PUSCH occasion configuration with the first quantity of PUSCH occasions and a second parameter indicating the second PUSCH occasion configuration with the second quantity of PUSCH occasions). In some examples, the information element may indicate a mapping between each parameter and a respective SSB index. For example, the first parameter may indicate that the first PUSCH occasion configuration is for the first beam associated with the first SSB index, and the second parameter may indicate that the second PUSCH occasion configuration is for the second beam associated with the second SSB index. In some examples, each parameter may indicate one or more additional SSB indices. For example, the first parameter may indicate the third SSB index associated with the third beam.

In some examples, at 310-a and 310-b, the UE 115-b and the network entity 105-b may identify a mapping between each information element or each parameter and each beam (e.g., each SSB index). That is, if the multiple information elements or the list of parameters do not explicitly indicate the SSB indices, the UE 115-b and the network entity 105-b may identify the mapping based on one or more attributes of the beams (e.g., quantities of configured RACH occasions per beam, transmit power or RSRP associated with each SSB). For example, the UE 115-b may identify a first attribute associated with the first beam (e.g., and accordingly the first SSB index), and may determine to map the first PUSCH configuration to the first SSB index based on the first attribute. The UE 115-b may identify a second attribute associated with the second beam, and may determine to map the second PUSCH configuration to the second beam based at least in part on the second attribute.

In some examples, at 315, the UE 115-b may receive, from the network entity 105-b, a control message indicating one or more PUSCH occasion configuration selection criteria (e.g., one or more thresholds, one or more quantities of PUSCH occasions). For example, the network entity 105-b may indicate a lowest RSRP threshold (e.g., associated with a largest quantity of PUSCH occasions) and one or more higher RSRP thresholds (e.g., associated with one or more smaller quantities of PUSCH occasions).

In some examples, at 320-a and 320-b, the UE 115-b and the network entity 105-b may select a subset of the uniform quantity of PUSCH occasions. That is, the UE 115-b and the network entity 105-b may determine the first PUSCH occasion configuration and the second PUSCH occasion configuration by selecting, for the first SSB index and the second SSB index, a first subset of PUSCH occasions (e.g., the first PUSCH occasion configuration) and a second subset of PUSCH occasions (e.g., the second PUSCH occasion configuration). For example, the UE 115-b and the network entity 105-b may select the first quantity of PUSCH occasions from the uniform quantity of PUSCH occasions based on the first attribute and the second quantity of PUSCH occasions based on the second attribute.

In some examples, the UE 115-b and the network entity 105-b may select the first subset and the second subset based on the one or more thresholds. For example, the UE 115-b may select the first subset of PUSCH occasions (e.g., the first PUSCH occasion configuration) and the second subset of PUSCH occasions (e.g., the second PUSCH occasion configuration) based on whether an RSRP associated with the first SSB index and an RSRP associated with the second beam index, respectively, satisfy one or more of the one or more thresholds.

In some examples, the UE 115-b and the network entity 105-b may select the first subset and the second subset based on the one or more quantities of PUSCH occasions indicated via the control message. For example, the UE 115-b may select the first subset of PUSCH occasions (e.g., the first PUSCH occasion configuration) and the second subset of PUSCH occasions (e.g., the second PUSCH occasion configuration) based on receiving an indication of the first quantity of PUSCH occasions for the first subset and an indication of the second quantity of PUSCH occasions for the second subset, respectively.

At 325, the UE 115-b may transmit the first RACH message (e.g., msgA) to the network entity 105-b. For example, the UE 115-b may transmit the first RACH message via the first beam (e.g., associated with the first SSB index and the first attribute) according to the first quantity of PUSCH occasions in the first PUSCH occasion configuration.

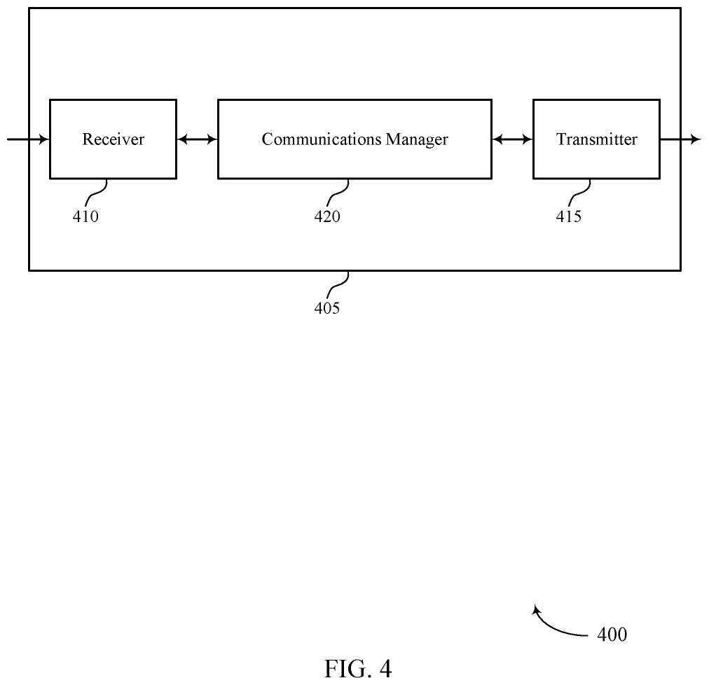

FIG. 4 shows a block diagram 400 of a device 405 that supports two-step random access enhancements for beam based operation for network energy savings in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, and the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to two-step random access enhancements for beam based operation for network energy savings). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to two-step random access enhancements for beam based operation for network energy savings). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of two-step random access enhancements for beam based operation for network energy savings as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor. If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving control information indicating one or more PUSCH occasion configurations for a first message of a two-step random access channel procedure, where the one or more PUSCH occasion configurations are associated with a set of multiple synchronization signal block indices. The communications manager 420 is capable of, configured to, or operable to support a means for transmitting, based on the control information, the first message of the two-step random access channel procedure via a first beam associated with a first synchronization signal block index of the set of multiple synchronization signal block indices and according to a first PUSCH occasion configuration, where the first PUSCH occasion configuration is different from a second PUSCH occasion configuration for a second beam associated with a second synchronization signal block index of the set of multiple synchronization signal block indices based on a first attribute of the first beam being different than a second attribute of the second beam.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for non-uniform distribution of PRACH occasions per beam, which may allow for reduced power consumption and more efficient utilization of communication resources.

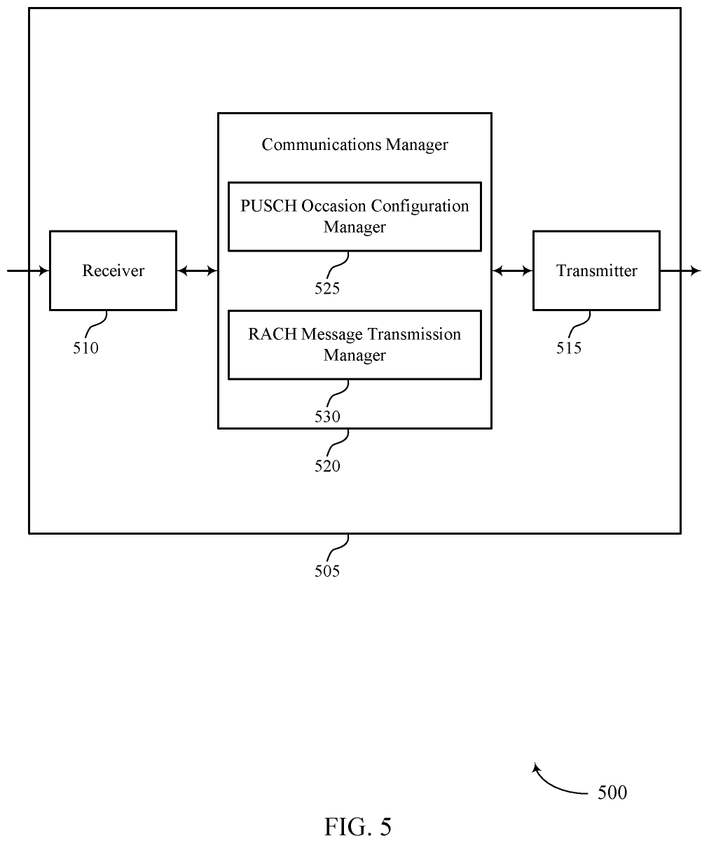

FIG. 5 shows a block diagram 500 of a device 505 that supports two-step random access enhancements for beam based operation for network energy savings in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to two-step random access enhancements for beam based operation for network energy savings). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to two-step random access enhancements for beam based operation for network energy savings). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of two-step random access enhancements for beam based operation for network energy savings as described herein. For example, the communications manager 520 may include an PUSCH occasion configuration manager 525 a RACH message transmission manager 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The PUSCH occasion configuration manager 525 is capable of, configured to, or operable to support a means for receiving control information indicating one or more PUSCH occasion configurations for a first message of a two-step random access channel procedure, where the one or more PUSCH occasion configurations are associated with a set of multiple synchronization signal block indices. The RACH message transmission manager 530 is capable of, configured to, or operable to support a means for transmitting, based on the control information, the first message of the two-step random access channel procedure via a first beam associated with a first synchronization signal block index of the set of multiple synchronization signal block indices and according to a first PUSCH occasion configuration, where the first PUSCH occasion configuration is different from a second PUSCH occasion configuration for a second beam associated with a second synchronization signal block index of the set of multiple synchronization signal block indices based on a first attribute of the first beam being different than a second attribute of the second beam.

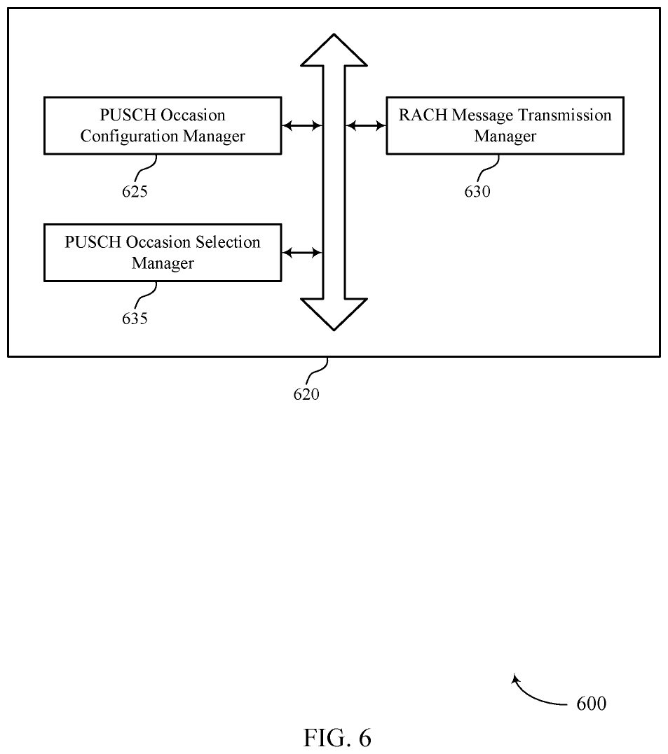

FIG. 6 shows a block diagram 600 of a communications manager 620 that supports two-step random access enhancements for beam based operation for network energy savings in accordance with one or more aspects of the present disclosure. The communications manager 620 may be an example of aspects of a communications manager 420, a communications manager 520, or both, as described herein. The communications manager 620, or various components thereof, may be an example of means for performing various aspects of two-step random access enhancements for beam based operation for network energy savings as described herein. For example, the communications manager 620 may include an PUSCH occasion configuration manager 625, a RACH message transmission manager 630, an PUSCH occasion selection manager 635, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The PUSCH occasion configuration manager 625 is capable of, configured to, or operable to support a means for receiving control information indicating one or more PUSCH occasion configurations for a first message of a two-step random access channel procedure, where the one or more PUSCH occasion configurations are associated with a set of multiple synchronization signal block indices. The RACH message transmission manager 630 is capable of, configured to, or operable to support a means for transmitting, based on the control information, the first message of the two-step random access channel procedure via a first beam associated with a first synchronization signal block index of the set of multiple synchronization signal block indices and according to a first PUSCH occasion configuration, where the first PUSCH occasion configuration is different from a second PUSCH occasion configuration for a second beam associated with a second synchronization signal block index of the set of multiple synchronization signal block indices based on a first attribute of the first beam being different than a second attribute of the second beam.

In some examples, to support receiving the control information, the PUSCH occasion configuration manager 625 is capable of, configured to, or operable to support a means for receiving a first information element indicating the first PUSCH occasion configuration, where the first PUSCH occasion configuration is associated with a first quantity of PUSCH occasions. In some examples, to support receiving the control information, the PUSCH occasion configuration manager 625 is capable of, configured to, or operable to support a means for receiving a second information element indicating the second PUSCH occasion configuration, where the second PUSCH occasion configuration is associated with a second quantity of PUSCH occasions different from the first quantity.

In some examples, the first information element includes an indication of the first synchronization signal block index and. In some examples, the second information element includes an indication of the second synchronization signal block index.

In some examples, the first information element includes an indication of a third synchronization signal block index associated with a third beam. In some examples, a third PUSCH occasion configuration for the third beam is associated with the first quantity of PUSCH occasions.

In some examples, the PUSCH occasion configuration manager 625 is capable of, configured to, or operable to support a means for identifying a mapping between the first synchronization signal block index and the first PUSCH occasion configuration based on the first attribute.

In some examples, to support receiving the control information, the PUSCH occasion configuration manager 625 is capable of, configured to, or operable to support a means for receiving a first information element including a first parameter indicating the first PUSCH occasion configuration and a second parameter indicating the second PUSCH occasion configuration, where the first PUSCH occasion configuration is associated with a first quantity of PUSCH occasions and the second PUSCH occasion configuration is associated with a second quantity of PUSCH occasions different from the first quantity.

In some examples, the first information element includes an indication of a mapping between the first synchronization signal block index and the first parameter and a mapping between the second synchronization signal block index and the second parameter.

In some examples, the first information element includes an indication of a mapping between the first parameter and a third synchronization signal block index associated with a third beam. In some examples, a third PUSCH occasion configuration for the third beam is associated with the first quantity of PUSCH occasions.

In some examples, the PUSCH occasion configuration manager 625 is capable of, configured to, or operable to support a means for identifying a mapping between the first synchronization signal block index and the first PUSCH occasion configuration based on the first attribute.

In some examples, to support receiving the control information, the PUSCH occasion configuration manager 625 is capable of, configured to, or operable to support a means for receiving an information element indicating a quantity of PUSCH occasions associated with the set of multiple synchronization signal block indices.

In some examples, the PUSCH occasion selection manager 635 is capable of, configured to, or operable to support a means for selecting a first subset of the quantity of PUSCH occasions based on the first attribute and a second subset of the quantity of PUSCH occasions based on the second attribute, where the first subset includes the first PUSCH occasion configuration and the second subset includes the second PUSCH occasion configuration.

In some examples, the PUSCH occasion selection manager 635 is capable of, configured to, or operable to support a means for receiving a control message indicating one or more thresholds, where selecting the first subset and the second subset is based on the one or more thresholds.

In some examples, the PUSCH occasion selection manager 635 is capable of, configured to, or operable to support a means for receiving a control message indicating a first quantity of PUSCH occasions in the first subset and a second quantity of PUSCH occasions in the second subset, where the first quantity and the second quantity are associated with the first synchronization signal block index and the second synchronization signal block index, respectively, and where selecting the first subset and the second subset is based on the first quantity and the second quantity.

In some examples, the first attribute and the second attribute include a first quantity of random access channel occasions associated with the first synchronization signal block index and a second quantity of random access channel occasions associated with the second synchronization signal block index, respectively.

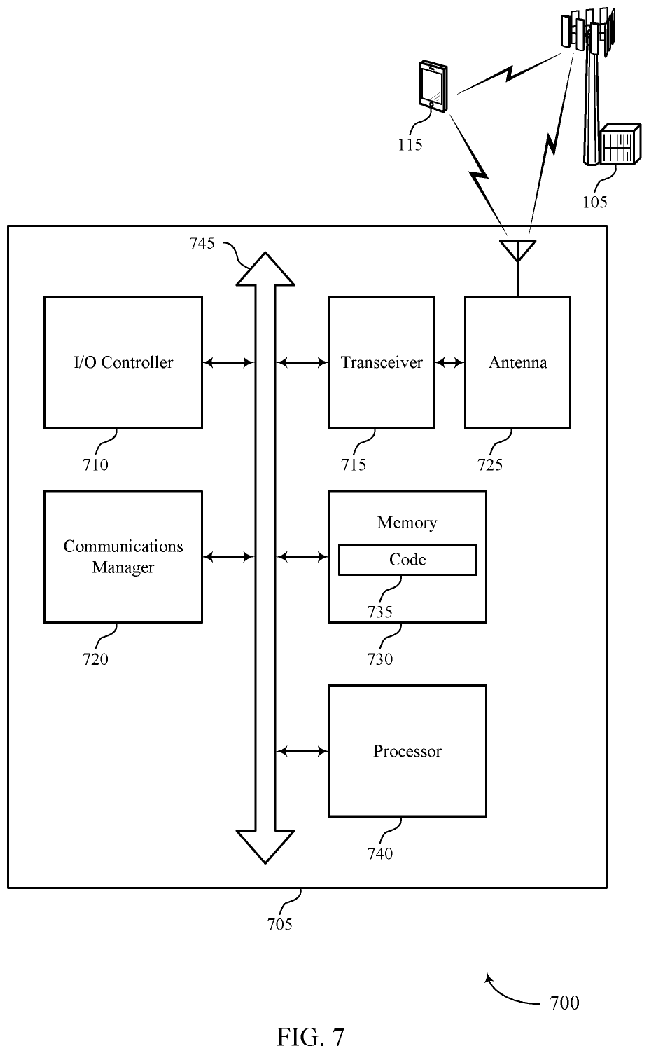

FIG. 7 shows a diagram of a system 700 including a device 705 that supports two-step random access enhancements for beam based operation for network energy savings in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOSR, ANDROIDR, MS-DOSR, MS-WINDOWSR, OS/2R, UNIXR, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable code 735 including instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may contain, among other things, a basic I/O system (BIOS) which may control basic hardware or software operation such as the interaction with peripheral components or devices.

The at least one processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting two-step random access enhancements for beam based operation for network energy savings). For example, the device 705 or a component of the device 705 may include at least one processor 740 and at least one memory 730 coupled with or to the at least one processor 740, the at least one processor 740 and at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving control information indicating one or more PUSCH occasion configurations for a first message of a two-step random access channel procedure, where the one or more PUSCH occasion configurations are associated with a set of multiple synchronization signal block indices. The communications manager 720 is capable of, configured to, or operable to support a means for transmitting, based on the control information, the first message of the two-step random access channel procedure via a first beam associated with a first synchronization signal block index of the set of multiple synchronization signal block indices and according to a first PUSCH occasion configuration, where the first PUSCH occasion configuration is different from a second PUSCH occasion configuration for a second beam associated with a second synchronization signal block index of the set of multiple synchronization signal block indices based on a first attribute of the first beam being different than a second attribute of the second beam.

By including or configuring the communications manager 720 in accordance with examples as described herein, the device 705 may support techniques for non-uniform distribution of PRACH occasions per beam, which may allow for reduced power consumption, more efficient utilization of communication resources, improved coordination between devices, and longer battery life.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of two-step random access enhancements for beam based operation for network energy savings as described herein, or the at least one processor 740 and the at least one memory 730 may be otherwise configured to, individually or collectively, perform or support such operations.

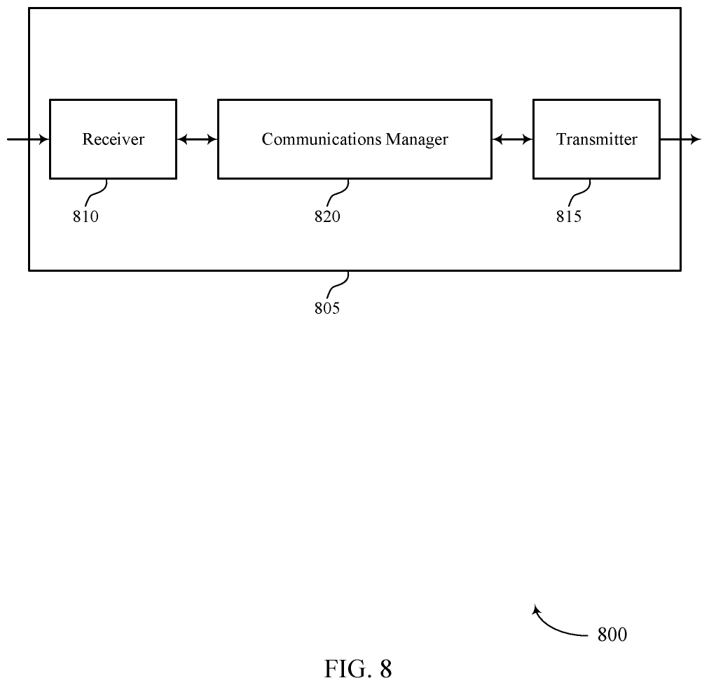

FIG. 8 shows a block diagram 800 of a device 805 that supports two-step random access enhancements for beam based operation for network energy savings in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of two-step random access enhancements for beam based operation for network energy savings as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting control information indicating one or more PUSCH occasion configurations for a first message of a two-step random access channel procedure, where the one or more PUSCH occasion configurations are associated with a set of multiple synchronization signal block indices. The communications manager 820 is capable of, configured to, or operable to support a means for obtaining, based on the control information, the first message of the two-step random access channel procedure via a first beam associated with a first synchronization signal block index of the set of multiple synchronization signal block indices and according to a first PUSCH occasion configuration, where the first PUSCH occasion configuration is different from a second PUSCH occasion configuration for a second beam associated with a second synchronization signal block index of the set of multiple synchronization signal block indices based on a first attribute of the first beam being different than a second attribute of the second beam.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for non-uniform distribution of PRACH occasions per beam, which may allow for reduced power consumption and more efficient utilization of communication resources.

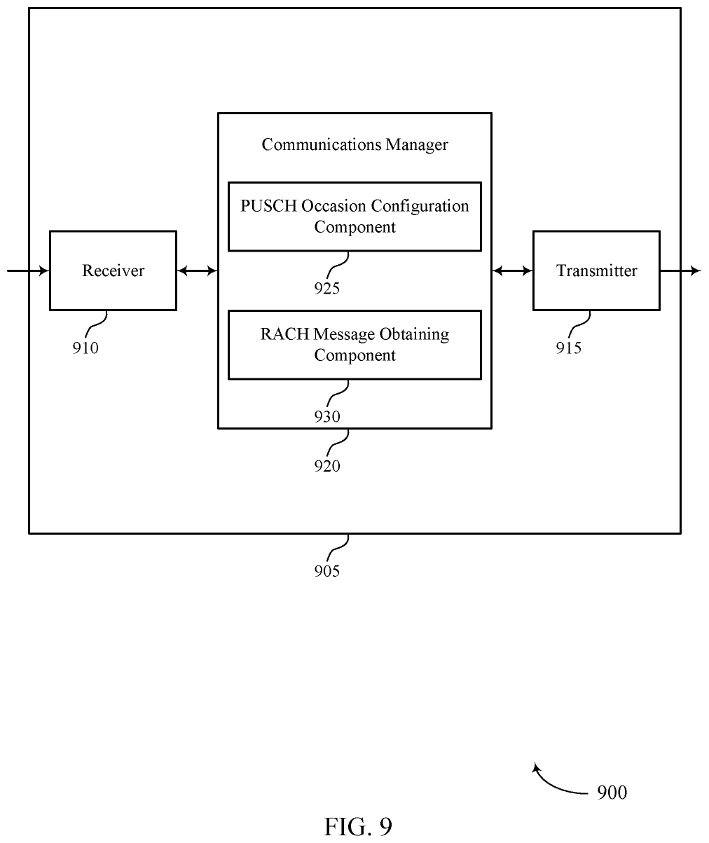

FIG. 9 shows a block diagram 900 of a device 905 that supports two-step random access enhancements for beam based operation for network energy savings in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of two-step random access enhancements for beam based operation for network energy savings as described herein. For example, the communications manager 920 may include an PUSCH occasion configuration component 925 a RACH message obtaining component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The PUSCH occasion configuration component 925 is capable of, configured to, or operable to support a means for outputting control information indicating one or more PUSCH occasion configurations for a first message of a two-step random access channel procedure, where the one or more PUSCH occasion configurations are associated with a set of multiple synchronization signal block indices. The RACH message obtaining component 930 is capable of, configured to, or operable to support a means for obtaining, based on the control information, the first message of the two-step random access channel procedure via a first beam associated with a first synchronization signal block index of the set of multiple synchronization signal block indices and according to a first PUSCH occasion configuration, where the first PUSCH occasion configuration is different from a second PUSCH occasion configuration for a second beam associated with a second synchronization signal block index of the set of multiple synchronization signal block indices based on a first attribute of the first beam being different than a second attribute of the second beam.

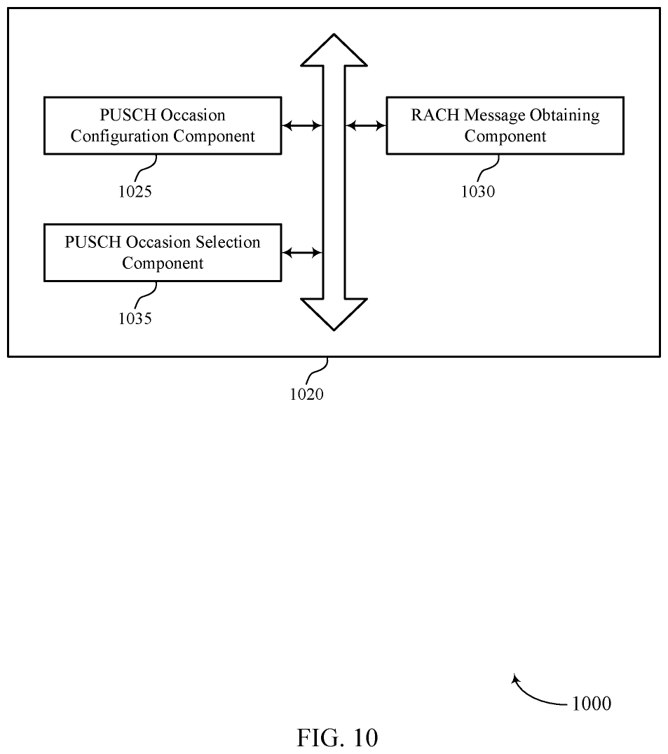

FIG. 10 shows a block diagram 1000 of a communications manager 1020 that supports two-step random access enhancements for beam based operation for network energy savings in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of two-step random access enhancements for beam based operation for network energy savings as described herein. For example, the communications manager 1020 may include an PUSCH occasion configuration component 1025, a RACH message obtaining component 1030, an PUSCH occasion selection component 1035, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The PUSCH occasion configuration component 1025 is capable of, configured to, or operable to support a means for outputting control information indicating one or more PUSCH occasion configurations for a first message of a two-step random access channel procedure, where the one or more PUSCH occasion configurations are associated with a set of multiple synchronization signal block indices. The RACH message obtaining component 1030 is capable of, configured to, or operable to support a means for obtaining, based on the control information, the first message of the two-step random access channel procedure via a first beam associated with a first synchronization signal block index of the set of multiple synchronization signal block indices and according to a first PUSCH occasion configuration, where the first PUSCH occasion configuration is different from a second PUSCH occasion configuration for a second beam associated with a second synchronization signal block index of the set of multiple synchronization signal block indices based on a first attribute of the first beam being different than a second attribute of the second beam.

In some examples, to support outputting the control information, the PUSCH occasion configuration component 1025 is capable of, configured to, or operable to support a means for outputting a first information element indicating the first PUSCH occasion configuration, where the first PUSCH occasion configuration is associated with a first quantity of PUSCH occasions. In some examples, to support outputting the control information, the PUSCH occasion configuration component 1025 is capable of, configured to, or operable to support a means for outputting a second information element indicating the second PUSCH occasion configuration, where the second PUSCH occasion configuration is associated with a second quantity of PUSCH occasions different from the first quantity.

In some examples, the first information element includes an indication of the first synchronization signal block index and. In some examples, the second information element includes an indication of the second synchronization signal block index.

In some examples, the first information element includes an indication of a third synchronization signal block index associated with a third beam. In some examples, a third PUSCH occasion configuration for the third beam is associated with the first quantity of PUSCH occasions.

In some examples, the PUSCH occasion configuration component 1025 is capable of, configured to, or operable to support a means for identifying a mapping between the first synchronization signal block index and the first PUSCH occasion configuration based on the first attribute.

In some examples, to support outputting the control information, the PUSCH occasion configuration component 1025 is capable of, configured to, or operable to support a means for outputting a first information element including a first parameter indicating the first PUSCH occasion configuration and a second parameter indicating the second PUSCH occasion configuration, where the first PUSCH occasion configuration is associated with a first quantity of PUSCH occasions and the second PUSCH occasion configuration is associated with a second quantity of PUSCH occasions different from the first quantity.

In some examples, the first information element includes an indication of a mapping between the first synchronization signal block index and the first parameter and a mapping between the second synchronization signal block index and the second parameter.

In some examples, the first information element includes an indication of a mapping between the first parameter and a third synchronization signal block index associated with a third beam. In some examples, a third PUSCH occasion configuration for the third beam is associated with the first quantity of PUSCH occasions.

In some examples, the PUSCH occasion configuration component 1025 is capable of, configured to, or operable to support a means for identifying a mapping between the first synchronization signal block index and the first PUSCH occasion configuration based on the first attribute.

In some examples, to support outputting the control information, the PUSCH occasion configuration component 1025 is capable of, configured to, or operable to support a means for outputting an information element indicating a quantity of PUSCH occasions associated with the set of multiple synchronization signal block indices.

In some examples, the PUSCH occasion selection component 1035 is capable of, configured to, or operable to support a means for selecting a first subset of the quantity of PUSCH occasions based on the first attribute and a second subset of the quantity of PUSCH occasions based on the second attribute, where the first subset includes the first PUSCH occasion configuration and the second subset includes the second PUSCH occasion configuration.

In some examples, the PUSCH occasion selection component 1035 is capable of, configured to, or operable to support a means for outputting a control message indicating one or more thresholds, where selecting the first subset and the second subset is based on the one or more thresholds.

In some examples, the PUSCH occasion selection component 1035 is capable of, configured to, or operable to support a means for outputting a control message indicating a first quantity of PUSCH occasions in the first subset and a second quantity of PUSCH occasions in the second subset, where the first quantity and the second quantity are associated with the first synchronization signal block index and the second synchronization signal block index, respectively, and where selecting the first subset and the second subset is based on the first quantity and the second quantity.

In some examples, the first attribute and the second attribute include a first quantity of random access channel occasions associated with the first synchronization signal block index and a second quantity of random access channel occasions associated with the second synchronization signal block index, respectively.

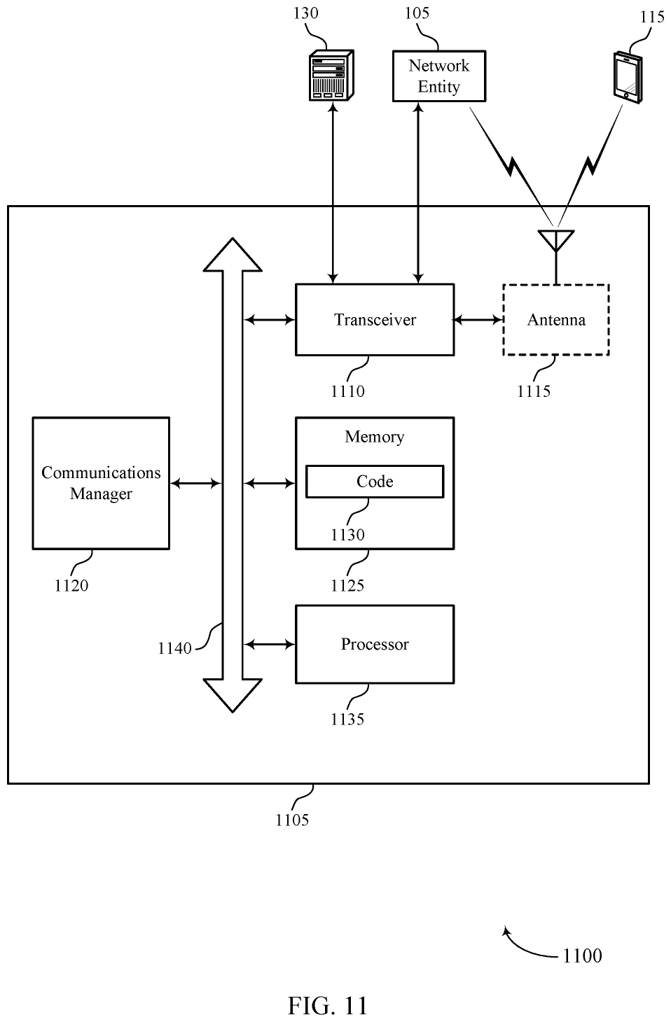

FIG. 11 shows a diagram of a system 1100 including a device 1105 that supports two-step random access enhancements for beam based operation for network energy savings in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., a communication link 125, a backhaul communication link 120, a midhaul communication link 162, a fronthaul communication link 168).

The at least one memory 1125 may include RAM, ROM, or any combination thereof. The at least one memory 1125 may store computer-readable, computer-executable code 1130 including instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may contain, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting two-step random access enhancements for beam based operation for network energy savings). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting control information indicating one or more PUSCH occasion configurations for a first message of a two-step random access channel procedure, where the one or more PUSCH occasion configurations are associated with a set of multiple synchronization signal block indices. The communications manager 1120 is capable of, configured to, or operable to support a means for obtaining, based on the control information, the first message of the two-step random access channel procedure via a first beam associated with a first synchronization signal block index of the set of multiple synchronization signal block indices and according to a first PUSCH occasion configuration, where the first PUSCH occasion configuration is different from a second PUSCH occasion configuration for a second beam associated with a second synchronization signal block index of the set of multiple synchronization signal block indices based on a first attribute of the first beam being different than a second attribute of the second beam.

By including or configuring the communications manager 1120 in accordance with examples as described herein, the device 1105 may support techniques for non-uniform distribution of PRACH occasions per beam, which may allow for reduced power consumption, more efficient utilization of communication resources, improved coordination between devices, and longer battery life.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of two-step random access enhancements for beam based operation for network energy savings as described herein, or the at least one processor 1135 and the at least one memory 1125 may be otherwise configured to, individually or collectively, perform or support such operations.

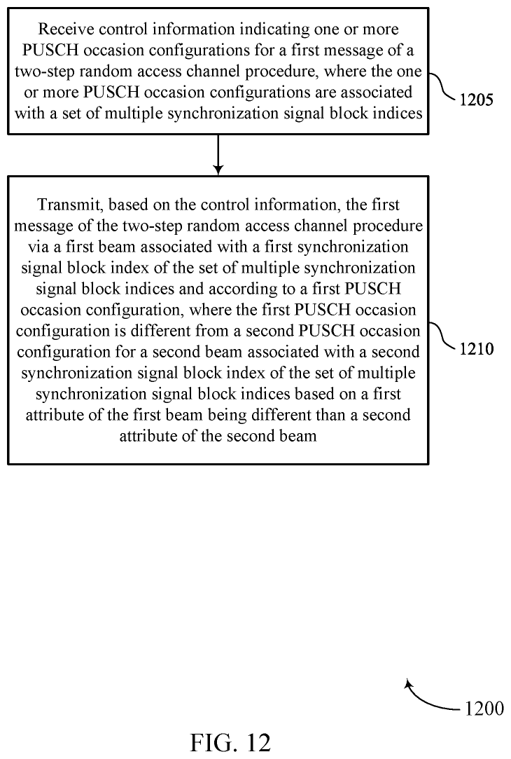

FIG. 12 shows a flowchart illustrating a method 1200 that supports two-step random access enhancements for beam based operation for network energy savings in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving control information indicating one or more PUSCH occasion configurations for a first message of a two-step random access channel procedure, where the one or more PUSCH occasion configurations are associated with a set of multiple synchronization signal block indices. The operations of 1205 may be performed in accordance with examples as disclosed herein. In some examples, aspects of the operations of 1205 may be performed by an PUSCH occasion configuration manager 625 as described with reference to FIG. 6.

At 1210, the method may include transmitting, based on the control information, the first message of the two-step random access channel procedure via a first beam associated with a first synchronization signal block index of the set of multiple synchronization signal block indices and according to a first PUSCH occasion configuration, where the first PUSCH occasion configuration is different from a second PUSCH occasion configuration for a second beam associated with a second synchronization signal block index of the set of multiple synchronization signal block indices based on a first attribute of the first beam being different than a second attribute of the second beam. The operations of 1210 may be performed in accordance with examples as disclosed herein. In some examples, aspects of the operations of 1210 may be performed by a RACH message transmission manager 630 as described with reference to FIG. 6.

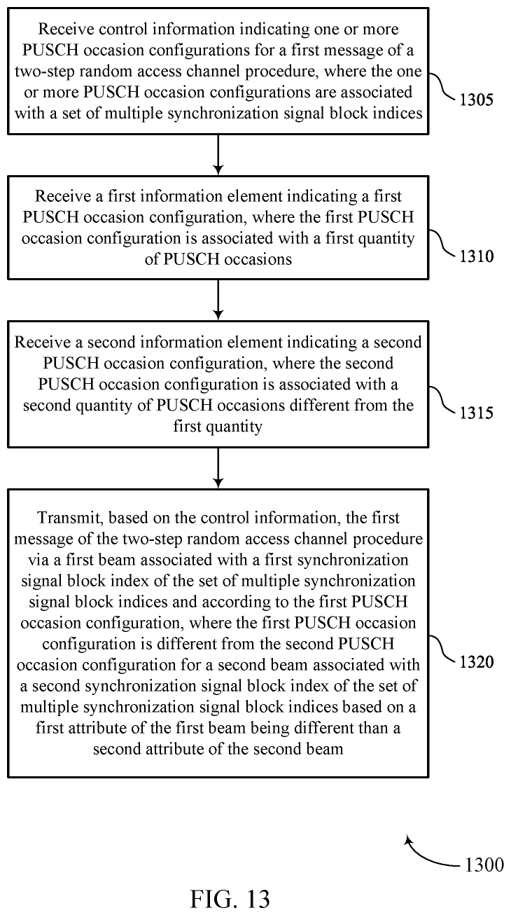

FIG. 13 shows a flowchart illustrating a method 1300 that supports two-step random access enhancements for beam based operation for network energy savings in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving control information indicating one or more PUSCH occasion configurations for a first message of a two-step random access channel procedure, where the one or more PUSCH occasion configurations are associated with a set of multiple synchronization signal block indices. The operations of 1305 may be performed in accordance with examples as disclosed herein. In some examples, aspects of the operations of 1305 may be performed by an PUSCH occasion configuration manager 625 as described with reference to FIG. 6.

At 1310, the method may include receiving a first information element indicating a first PUSCH occasion configuration, where the first PUSCH occasion configuration is associated with a first quantity of PUSCH occasions. The operations of 1310 may be performed in accordance with examples as disclosed herein. In some examples, aspects of the operations of 1310 may be performed by an PUSCH occasion configuration manager 625 as described with reference to FIG. 6.

At 1315, the method may include receiving a second information element indicating a second PUSCH occasion configuration, where the second PUSCH occasion configuration is associated with a second quantity of PUSCH occasions different from the first quantity. The operations of 1315 may be performed in accordance with examples as disclosed herein. In some examples, aspects of the operations of 1315 may be performed by an PUSCH occasion configuration manager 625 as described with reference to FIG. 6.

At 1320, the method may include transmitting, based on the control information, the first message of the two-step random access channel procedure via a first beam associated with a first synchronization signal block index of the set of multiple synchronization signal block indices and according to the first PUSCH occasion configuration, where the first PUSCH occasion configuration is different from the second PUSCH occasion configuration for a second beam associated with a second synchronization signal block index of the set of multiple synchronization signal block indices based on a first attribute of the first beam being different than a second attribute of the second beam. The operations of 1320 may be performed in accordance with examples as disclosed herein. In some examples, aspects of the operations of 1320 may be performed by a RACH message transmission manager 630 as described with reference to FIG. 6.

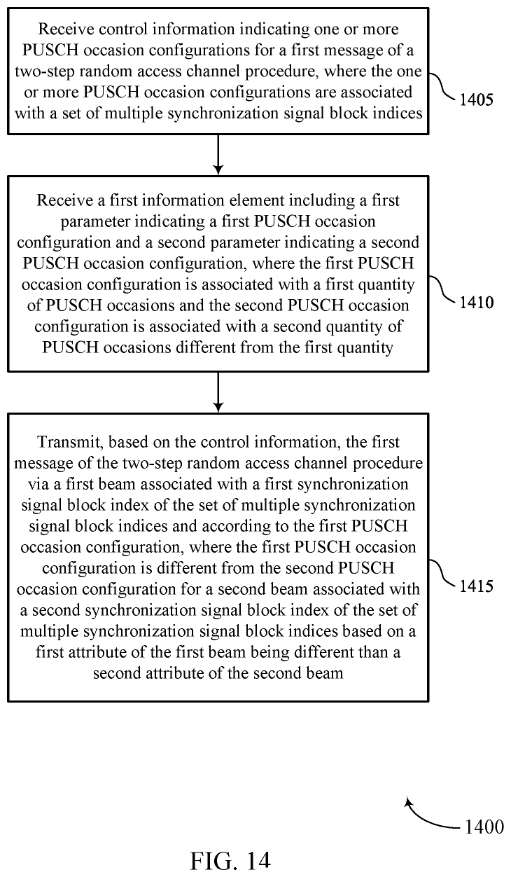

FIG. 14 shows a flowchart illustrating a method 1400 that supports two-step random access enhancements for beam based operation for network energy savings in accordance with aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include receiving control information indicating one or more PUSCH occasion configurations for a first message of a two-step random access channel procedure, where the one or more PUSCH occasion configurations are associated with a set of multiple synchronization signal block indices. The operations of 1405 may be performed in accordance with examples as disclosed herein. In some examples, aspects of the operations of 1405 may be performed by an PUSCH occasion configuration manager 625 as described with reference to FIG. 6.

At 1410, the method may include receiving a first information element including a first parameter indicating a first PUSCH occasion configuration and a second parameter indicating a second PUSCH occasion configuration, where the first PUSCH occasion configuration is associated with a first quantity of PUSCH occasions and the second PUSCH occasion configuration is associated with a second quantity of PUSCH occasions different from the first quantity. The operations of 1410 may be performed in accordance with examples as disclosed herein. In some examples, aspects of the operations of 1410 may be performed by an PUSCH occasion configuration manager 625 as described with reference to FIG. 6.

At 1415, the method may include transmitting, based on the control information, the first message of the two-step random access channel procedure via a first beam associated with a first synchronization signal block index of the set of multiple synchronization signal block indices and according to the first PUSCH occasion configuration, where the first PUSCH occasion configuration is different from the second PUSCH occasion configuration for a second beam associated with a second synchronization signal block index of the set of multiple synchronization signal block indices based on a first attribute of the first beam being different than a second attribute of the second beam. The operations of 1415 may be performed in accordance with examples as disclosed herein. In some examples, aspects of the operations of 1415 may be performed by a RACH message transmission manager 630 as described with reference to FIG. 6.

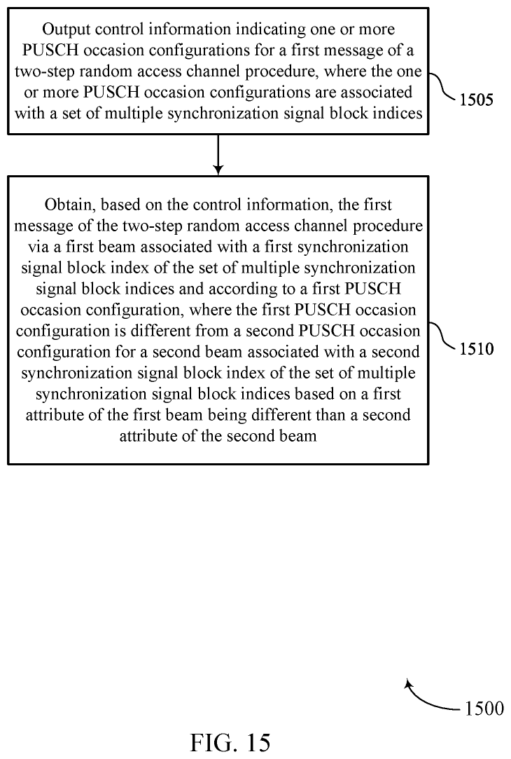

FIG. 15 shows a flowchart illustrating a method 1500 that supports two-step random access enhancements for beam based operation for network energy savings in accordance with aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include outputting control information indicating one or more PUSCH occasion configurations for a first message of a two-step random access channel procedure, where the one or more PUSCH occasion configurations are associated with a set of multiple synchronization signal block indices. The operations of 1505 may be performed in accordance with examples as disclosed herein. In some examples, aspects of the operations of 1505 may be performed by an PUSCH occasion configuration component 1025 as described with reference to FIG. 10.

At 1510, the method may include obtaining, based on the control information, the first message of the two-step random access channel procedure via a first beam associated with a first synchronization signal block index of the set of multiple synchronization signal block indices and according to a first PUSCH occasion configuration, where the first PUSCH occasion configuration is different from a second PUSCH occasion configuration for a second beam associated with a second synchronization signal block index of the set of multiple synchronization signal block indices based on a first attribute of the first beam being different than a second attribute of the second beam. The operations of 1510 may be performed in accordance with examples as disclosed herein. In some examples, aspects of the operations of 1510 may be performed by a RACH message obtaining component 1030 as described with reference to FIG. 10.

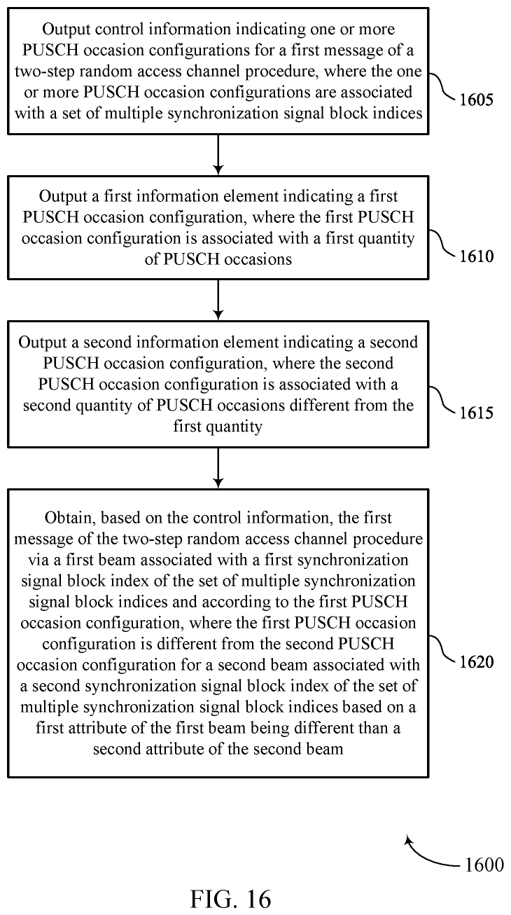

FIG. 16 shows a flowchart illustrating a method 1600 that supports two-step random access enhancements for beam based operation for network energy savings in accordance with aspects of the present disclosure. The operations of the method 1600 may be implemented by a network entity or its components as described herein. For example, the operations of the method 1600 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1605, the method may include outputting control information indicating one or more PUSCH occasion configurations for a first message of a two-step random access channel procedure, where the one or more PUSCH occasion configurations are associated with a set of multiple synchronization signal block indices. The operations of 1605 may be performed in accordance with examples as disclosed herein. In some examples, aspects of the operations of 1605 may be performed by an PUSCH occasion configuration component 1025 as described with reference to FIG. 10.

At 1610, the method may include outputting a first information element indicating a first PUSCH occasion configuration, where the first PUSCH occasion configuration is associated with a first quantity of PUSCH occasions. The operations of 1610 may be performed in accordance with examples as disclosed herein. In some examples, aspects of the operations of 1610 may be performed by an PUSCH occasion configuration component 1025 as described with reference to FIG. 10.

At 1615, the method may include outputting a second information element indicating a second PUSCH occasion configuration, where the second PUSCH occasion configuration is associated with a second quantity of PUSCH occasions different from the first quantity. The operations of 1615 may be performed in accordance with examples as disclosed herein. In some examples, aspects of the operations of 1615 may be performed by an PUSCH occasion configuration component 1025 as described with reference to FIG. 10.

At 1620, the method may include obtaining, based on the control information, the first message of the two-step random access channel procedure via a first beam associated with a first synchronization signal block index of the set of multiple synchronization signal block indices and according to the first PUSCH occasion configuration, where the first PUSCH occasion configuration is different from the second PUSCH occasion configuration for a second beam associated with a second synchronization signal block index of the set of multiple synchronization signal block indices based on a first attribute of the first beam being different than a second attribute of the second beam. The operations of 1620 may be performed in accordance with examples as disclosed herein. In some examples, aspects of the operations of 1620 may be performed by a RACH message obtaining component 1030 as described with reference to FIG. 10.

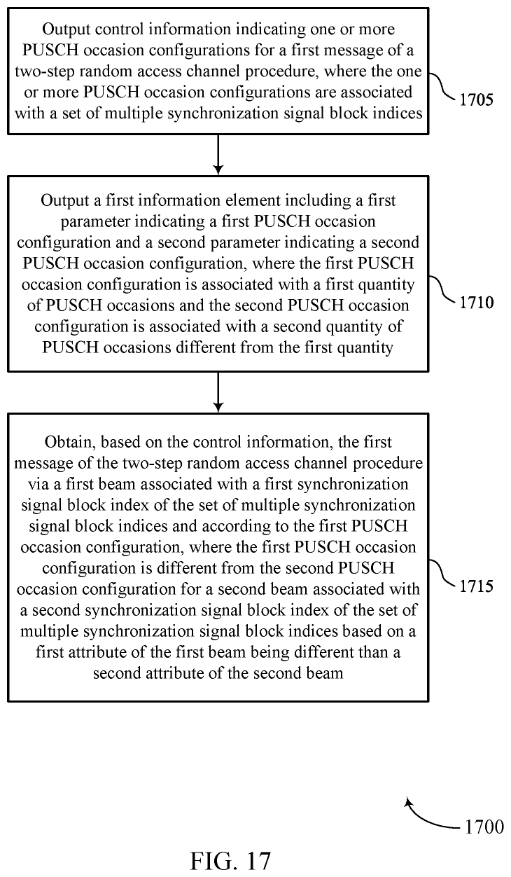

FIG. 17 shows a flowchart illustrating a method 1700 that supports two-step random access enhancements for beam based operation for network energy savings in accordance with aspects of the present disclosure. The operations of the method 1700 may be implemented by a network entity or its components as described herein. For example, the operations of the method 1700 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1705, the method may include outputting control information indicating one or more PUSCH occasion configurations for a first message of a two-step random access channel procedure, where the one or more PUSCH occasion configurations are associated with a set of multiple synchronization signal block indices. The operations of 1705 may be performed in accordance with examples as disclosed herein. In some examples, aspects of the operations of 1705 may be performed by an PUSCH occasion configuration component 1025 as described with reference to FIG. 10.

At 1710, the method may include outputting a first information element including a first parameter indicating a first PUSCH occasion configuration and a second parameter indicating a second PUSCH occasion configuration, where the first PUSCH occasion configuration is associated with a first quantity of PUSCH occasions and the second PUSCH occasion configuration is associated with a second quantity of PUSCH occasions different from the first quantity. The operations of 1710 may be performed in accordance with examples as disclosed herein. In some examples, aspects of the operations of 1710 may be performed by an PUSCH occasion configuration component 1025 as described with reference to FIG. 10.

At 1715, the method may include obtaining, based on the control information, the first message of the two-step random access channel procedure via a first beam associated with a first synchronization signal block index of the set of multiple synchronization signal block indices and according to the first PUSCH occasion configuration, where the first PUSCH occasion configuration is different from the second PUSCH occasion configuration for a second beam associated with a second synchronization signal block index of the set of multiple synchronization signal block indices based on a first attribute of the first beam being different than a second attribute of the second beam. The operations of 1715 may be performed in accordance with examples as disclosed herein. In some examples, aspects of the operations of 1715 may be performed by a RACH message obtaining component 1030 as described with reference to FIG. 10.

The following provides an overview of aspects of the present disclosure:

Aspect 1: A method for wireless communications by a UE, comprising: receiving control information indicating one or more PUSCH occasion configurations for a first message of a two-step RACH procedure, wherein the one or more PUSCH occasion configurations are associated with a plurality of SSB indices; and transmitting, based at least in part on the control information, the first message of the two-step RACH procedure via a first beam associated with a first SSB index of the plurality of SSB indices and according to a first PUSCH occasion configuration, wherein the first PUSCH occasion configuration is different from a second PUSCH occasion configuration for a second beam associated with a second SSB index of the plurality of SSB indices based at least in part on a first attribute of the first beam being different than a second attribute of the second beam.

Aspect 2: The method of aspect 1, wherein receiving the control information comprises: receiving a first information element indicating the first PUSCH occasion configuration, wherein the first PUSCH occasion configuration is associated with a first quantity of PUSCH occasions; and receiving a second information element indicating the second PUSCH occasion configuration, wherein the second PUSCH occasion configuration is associated with a second quantity of PUSCH occasions different from the first quantity.

Aspect 3: The method of aspect 2, wherein the first information element comprises an indication of the first SSB index and the second information element comprises an indication of the second SSB index.

Aspect 4: The method of aspect 3, wherein the first information element comprises an indication of a third SSB index associated with a third beam, a third PUSCH occasion configuration for the third beam is associated with the first quantity of PUSCH occasions.

Aspect 5: The method of any of aspects 2 through 4, further comprising: identifying a mapping between the first SSB index and the first PUSCH occasion configuration based at least in part on the first attribute.

Aspect 6: The method of aspect 1, wherein receiving the control information comprises: receiving a first information element comprising a first parameter indicating the first PUSCH occasion configuration and a second parameter indicating the second PUSCH occasion configuration, wherein the first PUSCH occasion configuration is associated with a first quantity of PUSCH occasions and the second PUSCH occasion configuration is associated with a second quantity of PUSCH occasions different from the first quantity.

Aspect 7: The method of aspect 6, wherein the first information element comprises an indication of a mapping between the first SSB index and the first parameter and a mapping between the second SSB index and the second parameter.

Aspect 8: The method of aspect 7, wherein the first information element comprises an indication of a mapping between the first parameter and a third SSB index associated with a third beam, a third PUSCH occasion configuration for the third beam is associated with the first quantity of PUSCH occasions.

Aspect 9: The method of any of aspects 6 through 8, further comprising: identifying a mapping between the first SSB index and the first PUSCH occasion configuration based at least in part on the first attribute.

Aspect 10: The method of aspect 1, wherein receiving the control information comprises: receiving an information element indicating a quantity of PUSCH occasions associated with the plurality of SSB indices.

Aspect 11: The method of aspect 10, further comprising: selecting a first subset of the quantity of PUSCH occasions based at least in part on the first attribute and a second subset of the quantity of PUSCH occasions based at least in part on the second attribute, wherein the first subset comprises the first PUSCH occasion configuration and the second subset comprises the second PUSCH occasion configuration.

Aspect 12: The method of aspect 11, further comprising: receiving a control message indicating one or more thresholds, wherein selecting the first subset and the second subset is based at least in part on the one or more thresholds.

Aspect 13: The method of any of aspects 11 through 12, further comprising: receiving a control message indicating a first quantity of PUSCH occasions in the first subset and a second quantity of PUSCH occasions in the second subset, wherein the first quantity and the second quantity are associated with the first SSB index and the second SSB index, respectively, and wherein selecting the first subset and the second subset is based at least in part on the first quantity and the second quantity.

Aspect 14: The method of any of aspects 1 through 13, wherein the first attribute and the second attribute comprise a first quantity of RACH occasions associated with the first SSB index and a second quantity of RACH occasions associated with the second SSB index, respectively.

Aspect 15: A method for wireless communications by a network entity, comprising: outputting control information indicating one or more PUSCH occasion configurations for a first message of a two-step RACH procedure, wherein the one or more PUSCH occasion configurations are associated with a plurality of SSB indices; and obtaining, based at least in part on the control information, the first message of the two-step RACH procedure via a first beam associated with a first SSB index of the plurality of SSB indices and according to a first PUSCH occasion configuration, wherein the first PUSCH occasion configuration is different from a second PUSCH occasion configuration for a second beam associated with a second SSB index of the plurality of SSB indices based at least in part on a first attribute of the first beam being different than a second attribute of the second beam.

Aspect 16: The method of aspect 15, wherein outputting the control information comprises: outputting a first information element indicating the first PUSCH occasion configuration, wherein the first PUSCH occasion configuration is associated with a first quantity of PUSCH occasions; and outputting a second information element indicating the second PUSCH occasion configuration, wherein the second PUSCH occasion configuration is associated with a second quantity of PUSCH occasions different from the first quantity.

Aspect 17: The method of aspect 16, wherein the first information element comprises an indication of the first SSB index and the second information element comprises an indication of the second SSB index.

Aspect 18: The method of aspect 17, wherein the first information element comprises an indication of a third SSB index associated with a third beam, a third PUSCH occasion configuration for the third beam is associated with the first quantity of PUSCH occasions.

Aspect 19: The method of any of aspects 16 through 18, further comprising: identifying a mapping between the first SSB index and the first PUSCH occasion configuration based at least in part on the first attribute.

Aspect 20: The method of aspect 15, wherein outputting the control information comprises: outputting a first information element comprising a first parameter indicating the first PUSCH occasion configuration and a second parameter indicating the second PUSCH occasion configuration, wherein the first PUSCH occasion configuration is associated with a first quantity of PUSCH occasions and the second PUSCH occasion configuration is associated with a second quantity of PUSCH occasions different from the first quantity.

Aspect 21: The method of aspect 20, wherein the first information element comprises an indication of a mapping between the first SSB index and the first parameter and a mapping between the second SSB index and the second parameter.

Aspect 22: The method of aspect 21, wherein the first information element comprises an indication of a mapping between the first parameter and a third SSB index associated with a third beam, a third PUSCH occasion configuration for the third beam is associated with the first quantity of PUSCH occasions.

Aspect 23: The method of any of aspects 20 through 22, further comprising: identifying a mapping between the first SSB index and the first PUSCH occasion configuration based at least in part on the first attribute.

Aspect 24: The method of aspect 15, wherein outputting the control information comprises: outputting an information element indicating a quantity of PUSCH occasions associated with the plurality of SSB indices.

Aspect 25: The method of aspect 24, further comprising: selecting a first subset of the quantity of PUSCH occasions based at least in part on the first attribute and a second subset of the quantity of PUSCH occasions based at least in part on the second attribute, wherein the first subset comprises the first PUSCH occasion configuration and the second subset comprises the second PUSCH occasion configuration.

Aspect 26: The method of aspect 25, further comprising: outputting a control message indicating one or more thresholds, wherein selecting the first subset and the second subset is based at least in part on the one or more thresholds.

Aspect 27: The method of any of aspects 25 through 26, further comprising: outputting a control message indicating a first quantity of PUSCH occasions in the first subset and a second quantity of PUSCH occasions in the second subset, wherein the first quantity and the second quantity are associated with the first SSB index and the second SSB index, respectively, and wherein selecting the first subset and the second subset is based at least in part on the first quantity and the second quantity.

Aspect 28: The method of any of aspects 15 through 27, wherein the first attribute and the second attribute comprise a first quantity of RACH occasions associated with the first SSB index and a second quantity of RACH occasions associated with the second SSB index, respectively

Aspect 29: A UE for wireless communications, comprising one or more memories storing processor-executable code, and one or more processors coupled with the one or more memories and individually or collectively operable to execute the code to cause the UE to perform a method of any of aspects 1 through 14.

Aspect 30: A UE for wireless communications, comprising at least one means for performing a method of any of aspects 1 through 14.

Aspect 31: A non-transitory computer-readable medium storing code for wireless communications, the code comprising instructions executable by one or more processors to perform a method of any of aspects 1 through 14.

Aspect 32: A network entity for wireless communications, comprising one or more memories storing processor-executable code, and one or more processors coupled with the one or more memories and individually or collectively operable to execute the code to cause the network entity to perform a method of any of aspects 15 through 28.

Aspect 33: A network entity for wireless communications, comprising at least one means for performing a method of any of aspects 15 through 28.

Aspect 34: A non-transitory computer-readable medium storing code for wireless communications, the code comprising instructions executable by one or more processors to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a.” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control information indicating one or more physical uplink shared channel (PUSCH) occasion configurations for a first message of a two-step random access channel procedure, wherein the one or more PUSCH occasion configurations are associated with a plurality of synchronization signal block indices; and
transmit, based at least in part on the control information, the first message of the two-step random access channel procedure via a first beam associated with a first synchronization signal block index of the plurality of synchronization signal block indices and according to a first PUSCH occasion configuration, wherein the first PUSCH occasion configuration is different from a second PUSCH occasion configuration for a second beam associated with a second synchronization signal block index of the plurality of synchronization signal block indices based at least in part on a first attribute of the first beam being different than a second attribute of the second beam.

2. The UE of claim 1, wherein, to receive the control information, the one or more processors are individually or collectively operable to execute the code to cause the UE to:
receive a first information element indicating the first PUSCH occasion configuration, wherein the first PUSCH occasion configuration is associated with a first quantity of PUSCH occasions; and
receive a second information element indicating the second PUSCH occasion configuration, wherein the second PUSCH occasion configuration is associated with a second quantity of PUSCH occasions different from the first quantity.

3. The UE of claim 2, wherein the first information element comprises an indication of the first synchronization signal block index, and wherein the second information element comprises an indication of the second synchronization signal block index.

4. The UE of claim 3, wherein the first information element comprises an indication of a third synchronization signal block index associated with a third beam, and wherein a third PUSCH occasion configuration for the third beam is associated with the first quantity of PUSCH occasions.

5. The UE of claim 2, wherein the one or more processors are individually or collectively further operable to execute the code to cause the UE to:
identify a mapping between the first synchronization signal block index and the first PUSCH occasion configuration based at least in part on the first attribute.

6. The UE of claim 1, wherein, to receive the control information, the one or more processors are individually or collectively operable to execute the code to cause the UE to:
receive a first information element comprising a first parameter indicating the first PUSCH occasion configuration and a second parameter indicating the second PUSCH occasion configuration, wherein the first PUSCH occasion configuration is associated with a first quantity of PUSCH occasions and the second PUSCH occasion configuration is associated with a second quantity of PUSCH occasions different from the first quantity.

7. The UE of claim 6, wherein the first information element comprises an indication of a mapping between the first synchronization signal block index and the first parameter and a mapping between the second synchronization signal block index and the second parameter.

8. The UE of claim 7, wherein the first information element comprises an indication of a mapping between the first parameter and a third synchronization signal block index associated with a third beam, and wherein a third PUSCH occasion configuration for the third beam is associated with the first quantity of PUSCH occasions.

9. The UE of claim 6, wherein the one or more processors are individually or collectively further operable to execute the code to cause the UE to:
identify a mapping between the first synchronization signal block index and the first PUSCH occasion configuration based at least in part on the first attribute.

10. The UE of claim 1, wherein, to receive the control information, the one or more processors are individually or collectively operable to execute the code to cause the UE to:
receive an information element indicating a quantity of PUSCH occasions associated with the plurality of synchronization signal block indices.

11. The UE of claim 10, wherein the one or more processors are individually or collectively further operable to execute the code to cause the UE to:
select a first subset of the quantity of PUSCH occasions based at least in part on the first attribute and a second subset of the quantity of PUSCH occasions based at least in part on the second attribute, wherein the first subset comprises the first PUSCH occasion configuration and the second subset comprises the second PUSCH occasion configuration.

12. The UE of claim 11, wherein the one or more processors are individually or collectively further operable to execute the code to cause the UE to:
receive a control message indicating one or more thresholds, wherein selecting the first subset and the second subset is based at least in part on the one or more thresholds.

13. The UE of claim 11, wherein the one or more processors are individually or collectively further operable to execute the code to cause the UE to:
receive a control message indicating a first quantity of PUSCH occasions in the first subset and a second quantity of PUSCH occasions in the second subset, wherein the first quantity and the second quantity are associated with the first synchronization signal block index and the second synchronization signal block index, respectively, and wherein selecting the first subset and the second subset is based at least in part on the first quantity and the second quantity.

14. The UE of claim 1, wherein the first attribute and the second attribute comprise a first quantity of random access channel occasions associated with the first synchronization signal block index and a second quantity of random access channel occasions associated with the second synchronization signal block index, respectively.

15. A network entity, comprising:
one or more memories storing processor-executable code; and
one or more processors coupled with the one or more memories and individually or collectively operable to execute the code to cause the network entity to:
output control information indicating one or more physical uplink shared channel (PUSCH) occasion configurations for a first message of a two-step random access channel procedure, wherein the one or more PUSCH occasion configurations are associated with a plurality of synchronization signal block indices; and
obtain, based at least in part on the control information, the first message of the two-step random access channel procedure via a first beam associated with a first synchronization signal block index of the plurality of synchronization signal block indices and according to a first PUSCH occasion configuration, wherein the first PUSCH occasion configuration is different from a second PUSCH occasion configuration for a second beam associated with a second synchronization signal block index of the plurality of synchronization signal block indices based at least in part on a first attribute of the first beam being different than a second attribute of the second beam.

16. The network entity of claim 15, wherein, to output the control information, the one or more processors are individually or collectively operable to execute the code to cause the network entity to:
output a first information element indicating the first PUSCH occasion configuration, wherein the first PUSCH occasion configuration is associated with a first quantity of PUSCH occasions; and
output a second information element indicating the second PUSCH occasion configuration, wherein the second PUSCH occasion configuration is associated with a second quantity of PUSCH occasions different from the first quantity.

17. The network entity of claim 16, wherein the first information element comprises an indication of the first synchronization signal block index, and wherein the second information element comprises an indication of the second synchronization signal block index.

18. The network entity of claim 17, wherein the first information element comprises an indication of a third synchronization signal block index associated with a third beam, and wherein a third PUSCH occasion configuration for the third beam is associated with the first quantity of PUSCH occasions.

19. The network entity of claim 16, wherein the one or more processors are individually or collectively further operable to execute the code to cause the network entity to:
identify a mapping between the first synchronization signal block index and the first PUSCH occasion configuration based at least in part on the first attribute.

20. The network entity of claim 15, wherein, to output the control information, the one or more processors are individually or collectively operable to execute the code to cause the network entity to:
output a first information element comprising a first parameter indicating the first PUSCH occasion configuration and a second parameter indicating the second PUSCH occasion configuration, wherein the first PUSCH occasion configuration is associated with a first quantity of PUSCH occasions and the second PUSCH occasion configuration is associated with a second quantity of PUSCH occasions different from the first quantity.

21. The network entity of claim 20, wherein the first information element comprises an indication of a mapping between the first synchronization signal block index and the first parameter and a mapping between the second synchronization signal block index and the second parameter.

22. The network entity of claim 21, wherein the first information element comprises an indication of a mapping between the first parameter and a third synchronization signal block index associated with a third beam, and wherein a third PUSCH occasion configuration for the third beam is associated with the first quantity of PUSCH occasions.

23. The network entity of claim 20, wherein the one or more processors are individually or collectively further operable to execute the code to cause the network entity to:
identify a mapping between the first synchronization signal block index and the first PUSCH occasion configuration based at least in part on the first attribute.

24. The network entity of claim 15, wherein, to output the control information, the one or more processors are individually or collectively operable to execute the code to cause the network entity to:
output an information element indicating a quantity of PUSCH occasions associated with the plurality of synchronization signal block indices.

25. The network entity of claim 24, wherein the one or more processors are individually or collectively further operable to execute the code to cause the network entity to:
select a first subset of the quantity of PUSCH occasions based at least in part on the first attribute and a second subset of the quantity of PUSCH occasions based at least in part on the second attribute, wherein the first subset comprises the first PUSCH occasion configuration and the second subset comprises the second PUSCH occasion configuration.

26. The network entity of claim 25, wherein the one or more processors are individually or collectively further operable to execute the code to cause the network entity to:
output a control message indicating one or more thresholds, wherein selecting the first subset and the second subset is based at least in part on the one or more thresholds.

27. The network entity of claim 25, wherein the one or more processors are individually or collectively further operable to execute the code to cause the network entity to:
output a control message indicating a first quantity of PUSCH occasions in the first subset and a second quantity of PUSCH occasions in the second subset, wherein the first quantity and the second quantity are associated with the first synchronization signal block index and the second synchronization signal block index, respectively, and wherein selecting the first subset and the second subset is based at least in part on the first quantity and the second quantity.

28. The network entity of claim 15, wherein the first attribute and the second attribute comprise a first quantity of random access channel occasions associated with the first synchronization signal block index and a second quantity of random access channel occasions associated with the second synchronization signal block index, respectively.

29. A method for wireless communications by a user equipment (UE), comprising:
receiving control information indicating one or more physical uplink shared channel (PUSCH) occasion configurations for a first message of a two-step random access channel procedure, wherein the one or more PUSCH occasion configurations are associated with a plurality of synchronization signal block indices; and
transmitting, based at least in part on the control information, the first message of the two-step random access channel procedure via a first beam associated with a first synchronization signal block index of the plurality of synchronization signal block indices and according to a first PUSCH occasion configuration, wherein the first PUSCH occasion configuration is different from a second PUSCH occasion configuration for a second beam associated with a second synchronization signal block index of the plurality of synchronization signal block indices based at least in part on a first attribute of the first beam being different than a second attribute of the second beam.

30. A method for wireless communications by a network entity, comprising:
outputting control information indicating one or more physical uplink shared channel (PUSCH) occasion configurations for a first message of a two-step random access channel procedure, wherein the one or more PUSCH occasion configurations are associated with a plurality of synchronization signal block indices; and
obtaining, based at least in part on the control information, the first message of the two-step random access channel procedure via a first beam associated with a first synchronization signal block index of the plurality of synchronization signal block indices and according to a first PUSCH occasion configuration, wherein the first PUSCH occasion configuration is different from a second PUSCH occasion configuration for a second beam associated with a second synchronization signal block index of the plurality of synchronization signal block indices based at least in part on a first attribute of the first beam being different than a second attribute of the second beam.
